(19) United States
(12) Patent Application Publication
(10) Pub. No.: US 2003/0138029 A1
(43) Pub. Date: Jul. 24, 2003

(54) Intergrated, High-performance, low-cost spread spectrum data access system and method

(76) Inventor: Keith J. Gerard, Chicago, IL (US)

Correspondence Address: Keith J. Gerard, 3721 W. 67th Place, Chicago, IL, 60629, US

(21) Appl. No.: 10/053,850

(22) Filed: Jan. 22, 2002

(51) Int. Cl. H04B 1/69; H04B 1/38

(52) U.S. Cl. 375/130; 375/222

(57) ABSTRACT

An integrated high-bandwidth spread spectrum data access system is provided. The high-bandwidth data access system includes at least one transmission cell capable of communicating with at least one Consumer Premises Equipment (CPE) in said cell. The transmission cell and CPE are remotely managed by a network management element. The system may be implemented over a public RF band and may dynamically self-configure its architecture to take advantage of optimal interference and user conditions. The CPE is installable by an end-user without the expense of a technician. The system is easily expandable and may be integrated with any of a variety of providers, including DSL and cable head ends, in a single data network.

### BACKGROUND OF THE INVENTION

The preferred embodiments of the present invention generally relate to a wireless communication system. More particularly, the preferred embodiments of the present invention relate to an integrated data access system that radically diminishes the effects of RF interference within spectrum, especially public spectrum, and circumvents the obstacles inherent to the pervasive and reliable deployment of data services within said spectrum. Additionally, the preferred embodiments of the present invention embody the fundamental characteristics of a provider-class data network solution while exhibiting exceptional cost-effectiveness through self-installation and auto-configuration of consumer premises equipment.

In today's increasingly digital world, data solutions that offer the capability for reliable high-bandwidth or ubiquitous data accessibility are tremendously desirable, especially in the context of commercial deployment.

Current high-bandwidth solutions such as Digital Subscriber Line (DSL) or broadband cable are undesirable to consumers and data access providers alike for a variety of reasons, including the fact that the physical deployment and maintenance of such network infrastructures is extraordinarily costly. Additionally, DSL and broadband cable rely heavily on physical wiring and equipment that may be expensive to install. A “truck roll” to a subscriber premises by a technician is commonly required for activation of service. Additionally, the DSL and broadband cable solutions may not be available to all prospective customers; for example, a DSL solution may be unavailable to a consumer who physically resides in an area that is inaccessible to a Central Office (CO) of the DSL provider. Current wireless data solutions, such as the integration of wireless modem services within existing cellular systems may be somewhat less costly to deploy. However, such services typically provide substandard data rates, sluggish performance, assert-pricey service fees, are impractical to integrate with other data devices, and are thus still undesirable.

Given the increased proliferation of spread spectrum data components such as wireless LANs (WLANs), recent efforts have been made to convert this nascent technology and its standards into an effective fixed wireless broadband solution. The comparatively low cost of material components coupled with its capacity for transmission within license-exempt spectrum, commonly regarded as “public spectrum,” have rendered spread spectrum data transmission as an emergent alternative for broadband accessibility.

However, numerous inefficiencies plague the practical deployment of this technology as a viable wireless alternative for data accessibility. Acute RF interference resulting from the obligatory co-existence of spread spectrum devices, especially within public spectrum, severely degrades the reliable transmission of data, consequently restricting the capability of pervasively deploying a reliable wireless data access infrastructure. Additionally, the data capacities inherent to a standard spread spectrum access node do not offer the scalability required of a provider-caliber data access service. Also, the limited transmission range characteristics of standard spread spectrum components that comply with the specified requirements for operation do not typically provide the coverage area essential to a provider-caliber wireless data access service. Also, the provisional and network management functionality indicative of a provider-caliber data access service is either grossly deficient or non-existent within available spread spectrum components. Moreover, the security features warranted in a provider-caliber data access service, such as the effective integration of security measures that prevent theft of service, cloning of equipment, and the widespread compromise of transmitted data, are fundamentally absent from available spread spectrum components. Furthermore, existing outdoor point-to-multipoint spread spectrum data access systems that are intended as a “last mile” data solution typically require the visit of a technician for device installation and service provisioning, thereby adding additional logistical expense comparable to the DSL and broadband cable service deployments referenced above.

Thus, a need has long existed for a data access solution that offers reliable wireless data connectivity and the capacity for high-bandwidth data transmission. A need has also long existed for such a solution that can be expeditiously and cost-effectively deployed without compromising the performance required of a provider-caliber data access system. Additionally, a need exists for such a solution to substantially seamlessly integrate with a variety of other data networks for the purpose of establishing an amalgamated data service with pervasive accessibility.

If spread spectrum devices are employed by a data access solution for the purpose of reliable data transmission in public spectrum, a need exists for the radical circumvention of RF interference inherent to the public spectrum. Also, a need exists for such a solution to improve the data capacities and scalability of a data access and retrieval system. Additionally, a need exists for such a solution that increases the transmission range and service area of a data service. Furthermore, a need exists for such a solution that offers the ability to provision and manage the network elements of a data access system in a manner indicative of a provider-caliber solution. Moreover, a need exists for such a solution that effectively guards against the compromise of transmitted data as well as the ability to combat theft of service.

Finally, a need has also long existed for such a solution that can be installed and provisioned by the intended subscriber of the data access system and does not require a technician to install equipment at the subscriber premises.

### SUMMARY OF THE INVENTION

The preferred embodiments of the present invention provide an integrates spread spectrum data access system. The system may be implemented over a public RF band, yet remain substantially free of in-band interference while at the same time providing high-speed data service at provider-quality rates. The system includes Consumer Premises Equipment (CPE) that is installable by an end-user without the expense of a technician. The system is easily expandable and may be integrated with any of a variety of providers, including DSL and cable head ends.

### BRIEF DESCRIPTION OF THE DRAWINGS

FIG. 1 illustrates a low-cost, high performance spread spectrum data access system according to the preferred embodiment of the present invention.

FIG. 2 illustrates an expanded functional view of the network management server according to the preferred embodiment of the present invention.

FIG. 3 illustrates an alternative preferred embodiment of the data access system where the network management server is remotely managed via the internet.

FIG. 4 illustrates an alternative preferred embodiment of the data access system where the network management server communicates with the data network from a remote location via the internet.

FIG. 5 illustrates an expanded functional view of the transmission cell and sectors according to a preferred embodiment of the present invention.

FIG. 6 illustrates an alternative preferred embodiment of the sectors without a power amplifier according to the present invention.

FIG. 7 illustrates an alternative preferred embodiment of the cell sectors without a power amplifier and RF channel filter according to the present invention.

FIG. 8A illustrates an alternative preferred embodiment of the cell data trunk that is configured for use with an MMDS communications network according to the present invention.

FIG. 8B illustrates an alternative preferred embodiment of the cell data trunk that is configured for use with a DSL communications network according to the present invention.

FIG. 8C illustrates an alternative preferred embodiment of the cell data trunk that is configured for use with a cable modem communications network according to the present invention.

FIG. 8D illustrates an alternative preferred embodiment of the cell data trunk that is configured for use with a satellite communications network according to the present invention.

FIG. 8E illustrates an alternative preferred embodiment of the cell data trunk that is configured for use with a fiber optic communications network according to the present invention.

FIG. 8F illustrates an alternative preferred embodiment of the cell data trunk that is configured for use with a dial-up communications network according to the present invention.

FIG. 8G illustrates an alternative preferred embodiment of the cell data trunk that is configured for use with an aircraft communications network or aircraft broadband communications network according to the present invention.

FIG. 8H illustrates an alternative preferred embodiment of the cell data trunk that is configured for use with an aircraft communications network or aircraft broadband communications network and is managed by the network management server via the internet according to the present invention.

FIG. 9A includes a table of a preferred embodiment of the segmentation of the United States FCC-authorized spread spectrum frequencies within the 2.4 GHz frequency range according to the present invention.

FIG. 9B illustrates spread spectrum waveforms within a direct sequence environment that include a frequency plan comprised of three discreet carriers according to the present invention.

FIG. 9C illustrates a standard spread spectrum cellular network topology within a direct sequence environment according to the present invention.

FIG. 9D illustrates spread spectrum waveforms within a direct sequence environment that comprise a frequency plan of three carriers that exhibit adjacent channel interference.

FIG. 9E illustrates spread spectrum waveforms within a direct sequence environment that comprise a frequency plan of two carriers that exhibit co-channel intersymbol interference.

FIG. 9F illustrates a preferred embodiment of an enhanced spread spectrum waveform within a direct sequence environment that is achieved through the deployment of RF filtering according to the present invention.

FIG. 9G illustrates a preferred embodiment of additional spread spectrum frequency plans within a direct sequence environment afforded by the implementation of RF filtering according to the present invention.

FIG. 9H illustrates a preferred embodiment of an enhanced spread spectrum cellular network topology within a direct sequence environment derived from the employment of RF filtering according to the present invention.

FIG. 10 illustrates a preferred embodiment of a frequency optimization utility according to the present invention.

FIG. 11A illustrates an expanded functional view of the CPE device according to the preferred embodiment of the present invention.

FIG. 11B illustrates an alternative preferred embodiment of the CPE device without a power amplifier according to the present invention.

FIG. 12 illustrates an alternative preferred embodiment of the CPE device with a wireless communication link according to the present invention.

FIG. 13 illustrates a flowchart that represents a preferred embodiment of an authentication and configuration sequence for initializing a CPE device to the data access system according to the present invention.

### DETAILED DESCRIPTION OF THE PREFERRED EMBODIMENTS

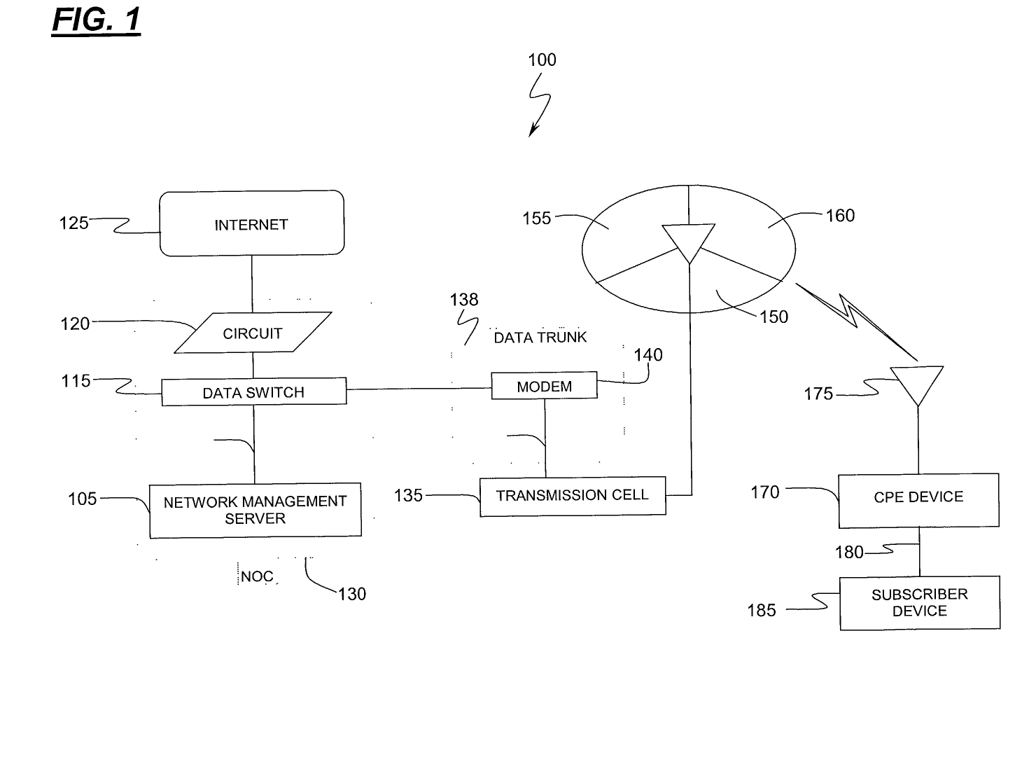

FIG. 1 illustrates a low-cost, high performance spread spectrum data access system 100 according to a preferred embodiment of the present invention. The data access system 100 includes a network management server 105, a transmission cell 135 and one or more Customer Premises Equipment (CPE) devices 170. Multiple network transmission cells 135 may be deployed within the data access system 100 to create an amalgamated data network over a widespread geographic area.

A “data network” may be defined as communication between the elements of the data access system 100. These elements fundamentally include a network management server 105, one or more transmission cells 135, and one or more CPE devices 170 as described above.

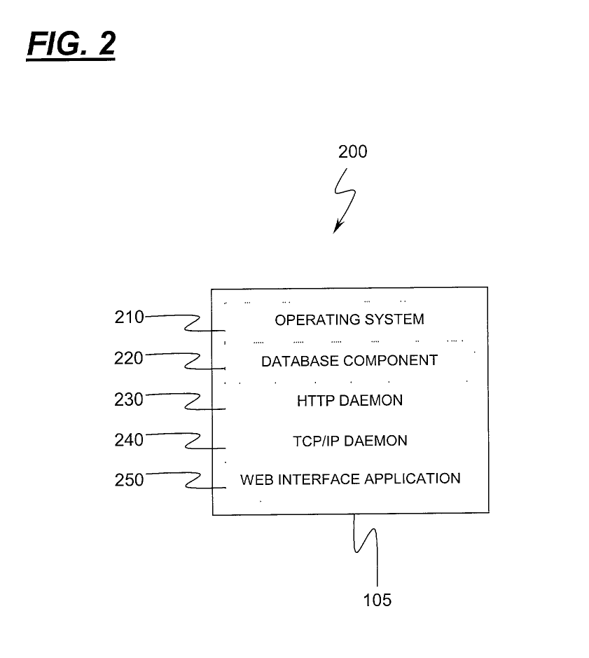

The network management server 105 is preferably located at the Network Operations Center (NOC) 130 of the data access system 100. The NOC is a physical location that functions as a single point of contact to handle configuration, management, and monitoring of the data access system 100. The network management server 105 communicates with the data network, which may be accessible via a data switch 115, hub (not shown) or similar device located at the NOC. The network management server is preferably coupled with the switch via an ethernet link 110. Additionally, the data switch may be integrated with connectivity to the internet 125 via a modem, router, or high-speed circuit 120, such as a T1 or T3 circuit, especially if connectivity to the internet 125 is a desired service feature of the data access system 100. Preferably, the network management server 105 includes a variety of application components that may be operationally regarded as “administrative” or “data flow” applications. The preferred embodiment of these network management server 105 applications is disclosed in FIG. 2 below, which illustrates an expanded functional view 200 of the network management server 205.

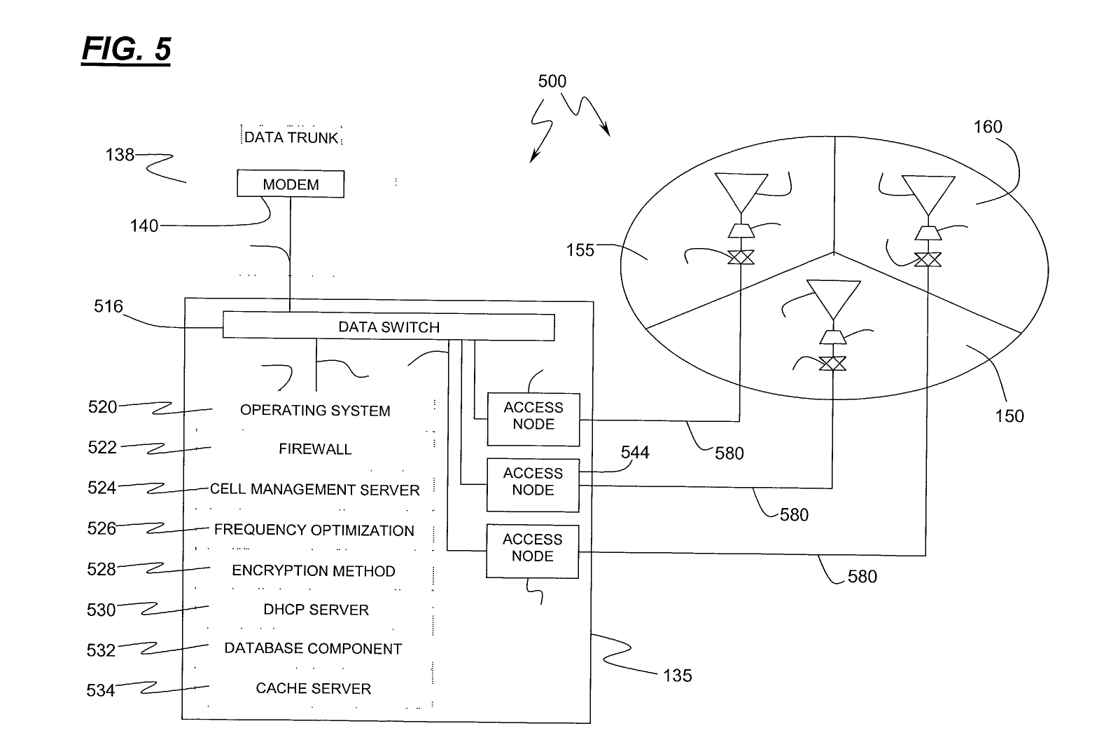

The transmission cell 135 is generally located in an area where the point-to-point or point-to-multipoint transmission of the data network is desired. The transmission cell 135 may interface with the data access system 100, and therefore the data network, via a wired or wireless communication device that may commonly serve as a “data trunk” 138 such as a modem 140, T1 circuit, or fiber-optic connection. The transmission cell 135 is preferably coupled with the modem 140 via an ethernet link 110. The modem 140 may directly communicate with the data network by interfacing with a data switch 115 or similar device located at the NOC 130 of the data access system 100. The transmission cell 135 may provide 360 degrees of transmission coverage for the purpose of communication with one or more CPE devices 170. The 360 degrees of coverage of the transmission cell 135 may be segmented into multiple cell sectors of a predetermined degree of angular variance. For example, the transmission cell 135 may be segmented into the three cell sectors 150, 155, 160 of 120 degrees each as shown in FIG. 1. The transmission cell 135 may be segmented or “sectorized” for the purpose of increasing the gain, range and data capacity of the cell transmission. Preferably, the transmission cell 135 includes a variety of application components that may be operationally regarded as “administrative” or “data flow” applications. These applications may be found in the management element 518 of the transmission cell 135, as further described below. The preferred embodiment of these transmission cell applications is disclosed in FIG. 5 below, which illustrates an expanded functional view 500 of the transmission cell 135 and the three cell sectors 150, 155, 160.

The CPE device 170 is generally located in an area where connectivity to the data network is desired, such as a subscriber premises. The CPE device 170 includes a wireless transceiver 175 and one or more communication links 180. The communication link 180 is preferably an ethernet communication link, a USB communication link, or an IEEE 1394 FireWire communication link, for example. The CPE device 170 may be attached to a multitude of other subscriber devices 185 such as a personal computer (PC) or other network device such as a data switch or hub (not shown) via the communication link 180. The CPE device 170 is preferably an effective data routing solution and may also include functionality as a modem. Preferably, the CPE device 170 includes a variety of application components that may be operationally regarded as “attendant” applications. A preferred embodiment of these CPE device 170 applications is disclosed in FIG. 1A below, which illustrates an expanded functional view 1100 of the CPE device 170.

Alternatively, the CPE device 170 may be generally regarded as any device that has the capability to effectively communicate with the data network. This includes devices, such as personal computers, handheld or data devices, with integrated or compatible circuitry that allows for wireless communication using the frequencies transmitted within range of the transmission cell 135.

In operation, the data access system 100 includes the network management server 105 as the primary network device for fundamental administrative tasks. The functionality of the network management server 105 preferably includes the provisioning of network subscribers within the data access system 100, the authentication of network subscribers, the remote configuration and functional management of transmission cells 135 within the data access system 100, the monitoring and administration of network operations such as packet routing of the data access system 100, and subscriber accounting. These tasks may be accomplished via automated operation of the network management server 105 or manual operation by an administrator of the data access system 100 from within the NOC 130.

Additionally, the network management server 105 may interface with a network administration tool such as RADIUS (Remote Authentication Dial-In User Service) or similar administration application for the purpose of providing substantially seamless and rapid integration of the data access system 100 within a pre-existing data network such as an internet service provider (ISP) network.

The transmission cell 135 transmits data to the CPE device 170 that is located inside one of potentially multiple cell sectors 150, 155, 160 of the network transmission cell. In effect, the transmission cell 135 bridges communication between the CPE device 170 and the data access system 100 at large. The transmission cell 135 may be effectively regarded as a network “point-of-presence” (POP) for one or more CPE devices 170 within the data access system 100.

The CPE device 170 may communicate with the transmission cell 135 via a wireless transceiver 175 such as a spread spectrum antenna, or similar device that may be commonly regarded as an intentional radiator that communicates with the transmission cell 135. Additionally, the CPE device 170 may wirelessly transmit data originating from or destined to the transmission cell 135 to other subscriber devices in the manner of a wireless data repeater, bridge or router.

FIG. 2 illustrates an expanded functional view 200 of the network management server 105 according to the preferred embodiment of the present invention. Preferably, the network management server 105 includes a database component 220, an HTTP daemon 230 that is preferably SSL-compliant, and a TCP/IP daemon 240 for communication with the cell management server 524 referenced in FIG. 5 below. The network management server 105 preferably also includes an operating system 210 that is preferably based upon an open-sourced platform such as Linux or FreeBSD

Additionally, the network management server 105 preferably includes a web front-end interface application 250 that may interact with the HTTP daemon 230 of the network management server 105. The web front-end interface application 250 allows for the remote operation of the network management server 105. This provides the ability to configure, manage, and monitor the elements of the data access system 100 using a standard web browser or similar application.

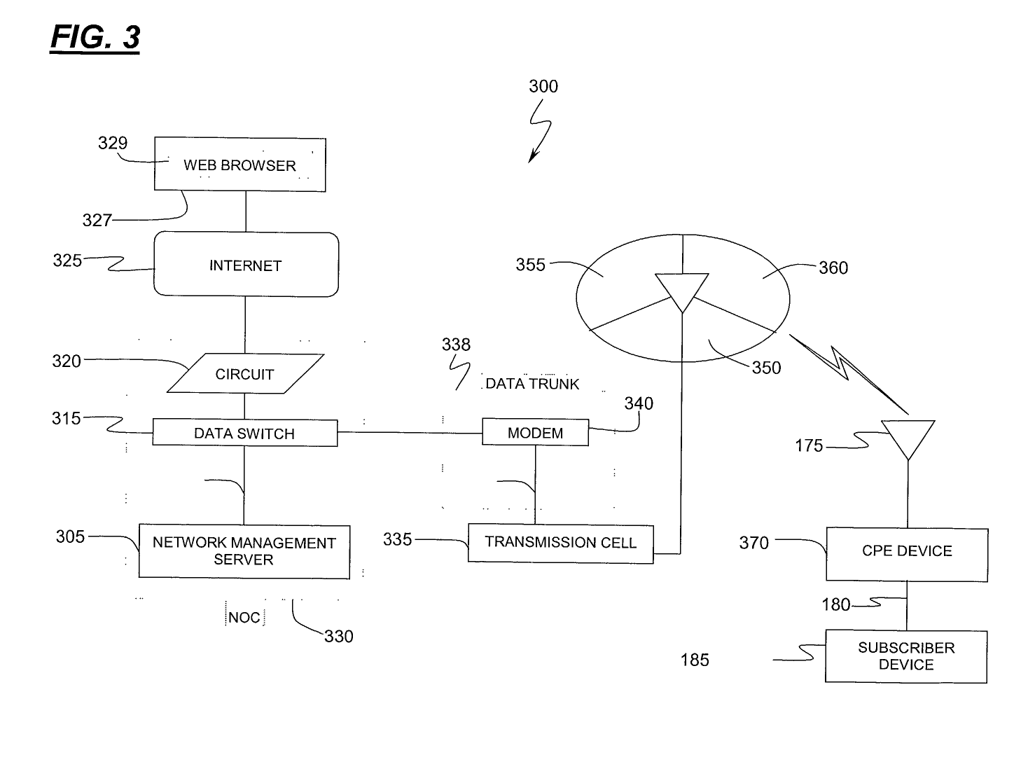

FIG. 3 illustrates an alternative preferred embodiment of the data access system 300 where the network management server 305 is remotely managed via the internet. For example, any device that includes a web browser, such as a personal computer, and is capable of interacting with the data network, using the internet, for example, may remotely manage the administration and configuration of a transmission cell 135 or CPE device 170 within the data access system 100.

The data access system 300 includes the network management server 305, the transmission cell 335, the cell data trunk 338, the cell sectors 350, 355, 360, and the CPE device 370 similar to FIG. 1.

The network management server 305 is physically located at the NOC 330, and may be connected to the internet 325 via an ethernet link 310, a switch 315, and a high-speed circuit 320 in similar fashion to FIG. 1. The transmission cell 135 may communicate with the data network using a modem 340 or other device as a cell data trunk 338 similar to FIG. 1. Additionally, a data device 327, such as a personal computer, that includes a web browser application 329 is connected to the internet 325 from a location other than the NOC 330.

In operation, the web browser application 329 of the data device 327 interacts with the web interface application 250 of the network management server 305 via the internet 325. In this manner, the network management server 305 may be remotely operated from a location other than the NOC 330, allowing for the remote management and configuration of other elements within the data access system 300, which include the transmission cell 335 and CPE device 370. Alternatively, the network management server 305 may be physically located anywhere communication with the data network can be attained.

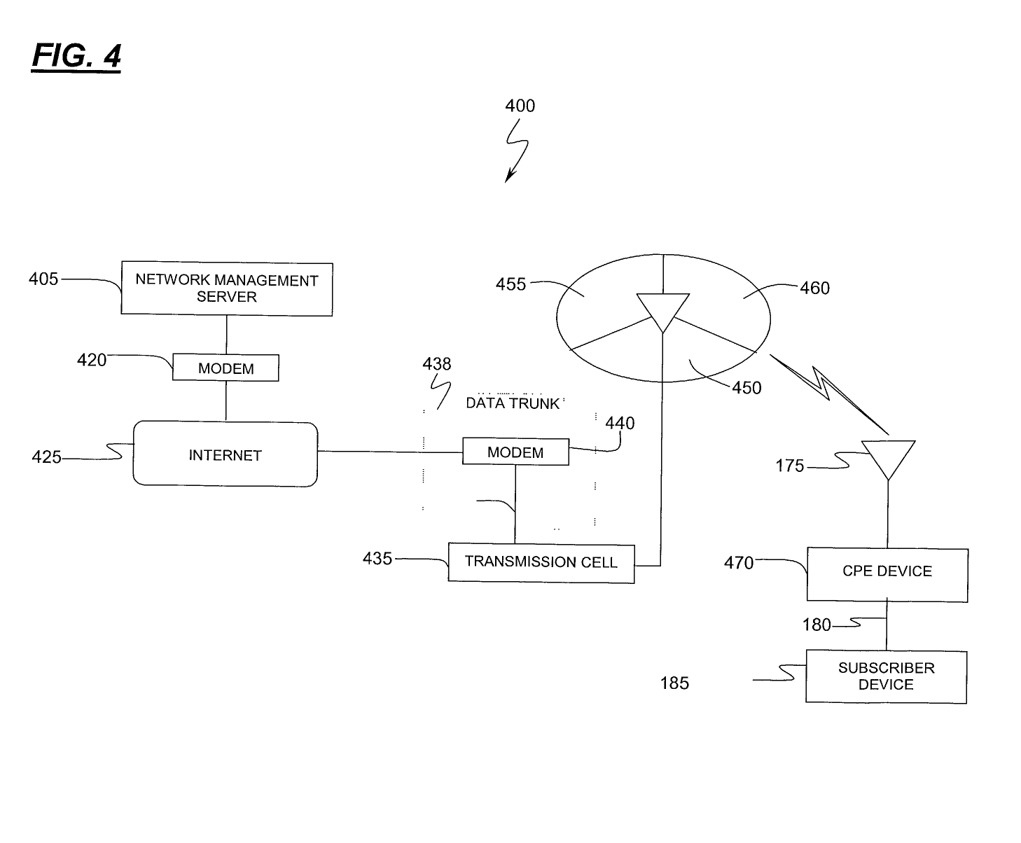

FIG. 4 illustrates an alternative preferred embodiment of the data access system 400 where the network management server 405 communicates with the data network from a remote location via the internet. That is, the network management server 405 may communicate with the data network, which includes the transmission cell 435 and the CPE device 470, from a location other than the NOC 430 via the internet 425

The data access system 400 includes the network management server 405, the transmission cell 435, the cell data trunk 438, the cell sectors 450, 455, 460, and the CPE device 470 similar to FIG. 1.

The network management server 405 may be connected to the data network via the internet 425 using a modem 420, or integrated into a LAN or WAN that supports accessibility to the internet 425. The transmission cell 435 may interface with the data network via the internet 425 using a modem 440 or other device as a cell data trunk 438. Other elements of the data network may also be connected to the data network via the internet 425. In this manner, the network management server 405 may be physically located anywhere accessibility to the internet 425 is available, allowing for the management and configuration of other elements within the data access system 400, which include the transmission cell 435 and CPE device 470. This assumes that the data network has connectivity to the internet 425, and assumes that the transmission cell 435 has the ability to communicate with the data network, either through direct connectivity to the network management server 405 or remotely through the internet 425.

FIG. 5 illustrates an expanded functional view 500 of the transmission cell 135 and cell sectors 150, 155, 160 according to a preferred embodiment of the present invention. Generally speaking, the transmission cell 135 includes a cell data trunk 138 such as a modem 140 or other device for wired or wireless connectivity with the data network of the data access system 100. The modem 140 is preferably integrated with the application elements of the transmission cell 135 using a data switch 516 or similar device. The modem 140 is preferably coupled with the data switch 516 via an ethernet link 110. Each of the three cell sectors 150, 155, 160 includes a sector antenna 552, 554, 556, an RF channel filter 562, 564, 566, and a power amplifier 572, 574, 576 or booster that preferably incorporates an automatic gain control (AGC) feature. The sector antenna 552, 554, 556 preferably employs a circular polarization pattern. The collective functionality of the antenna, filter, and power amplifier may physically exist as a single, integrated component or operate independently as separate devices.

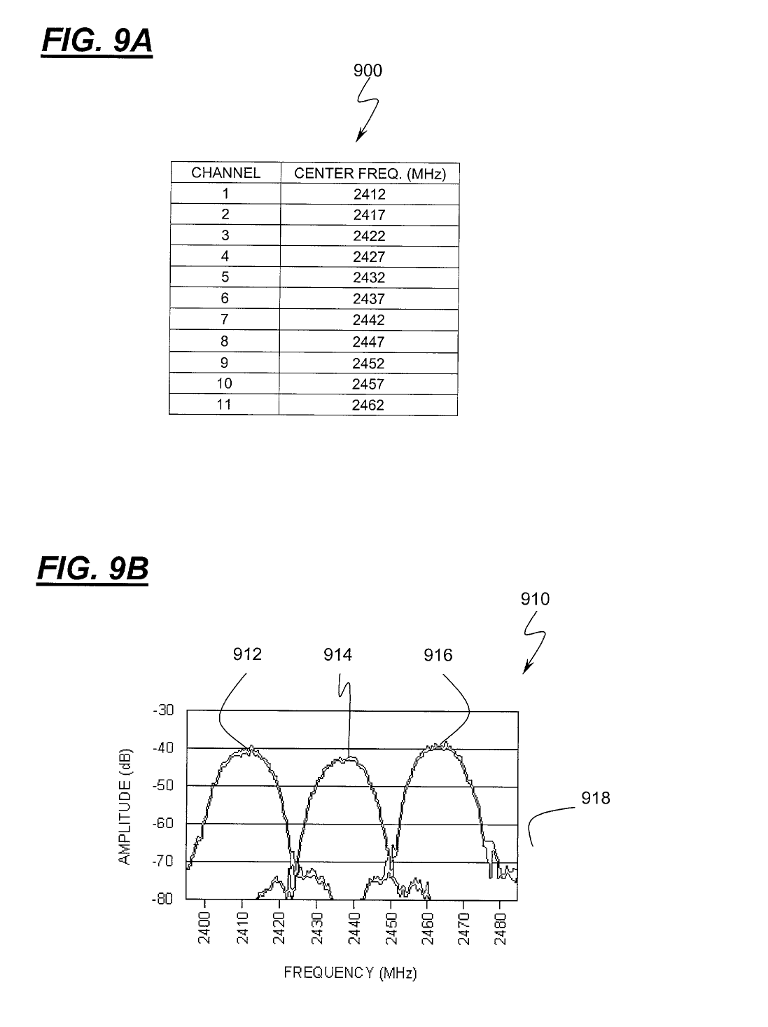

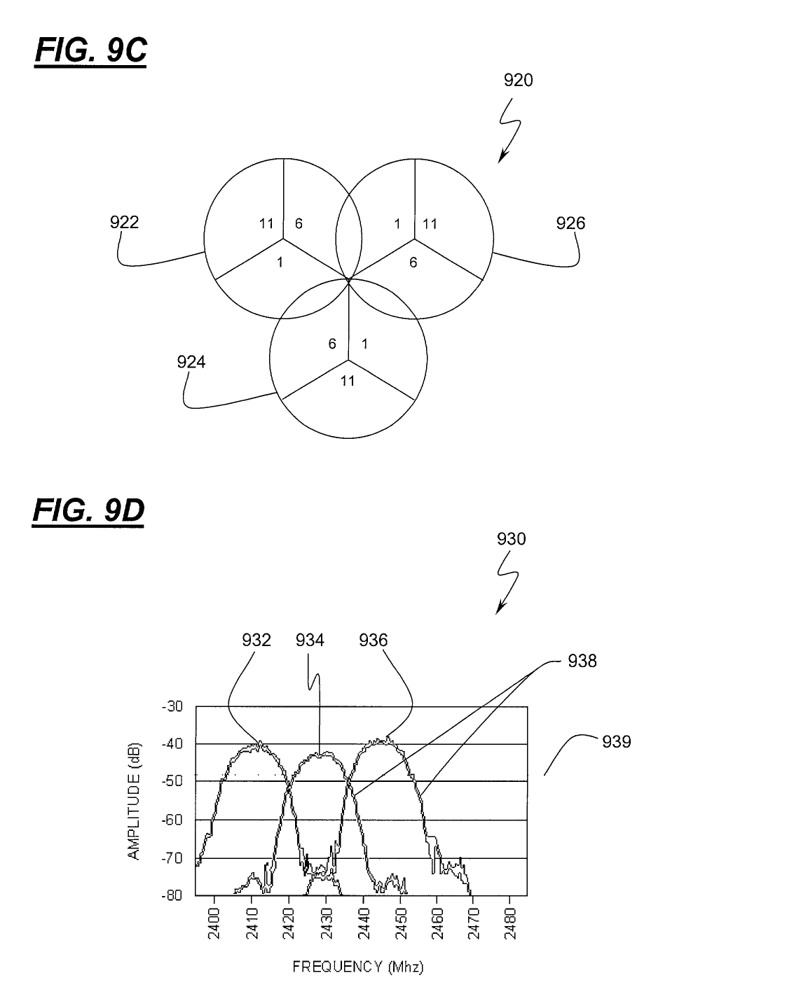

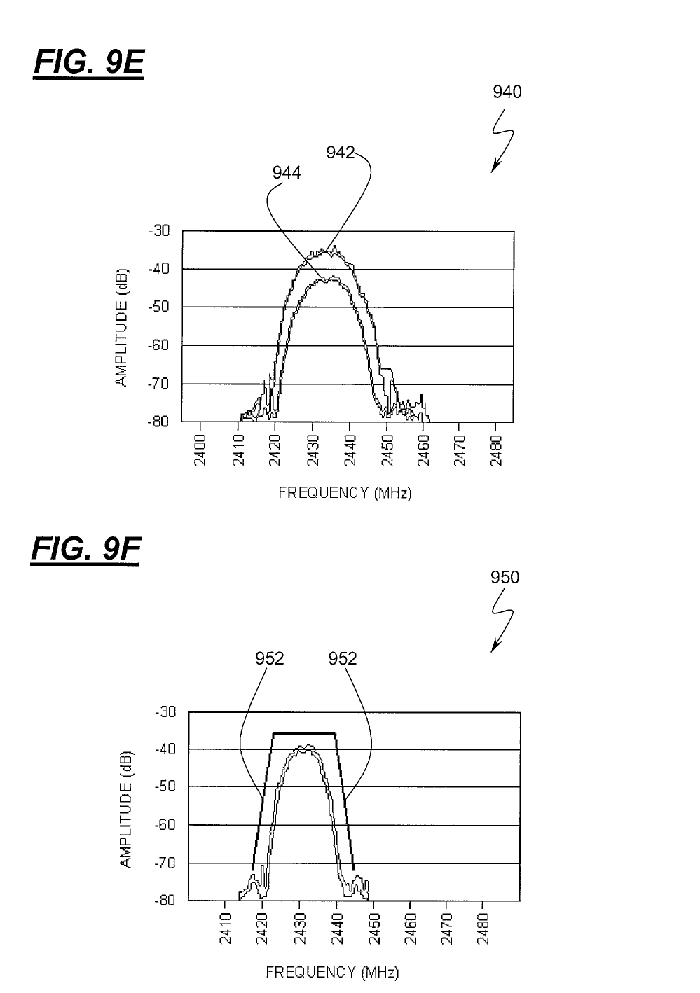

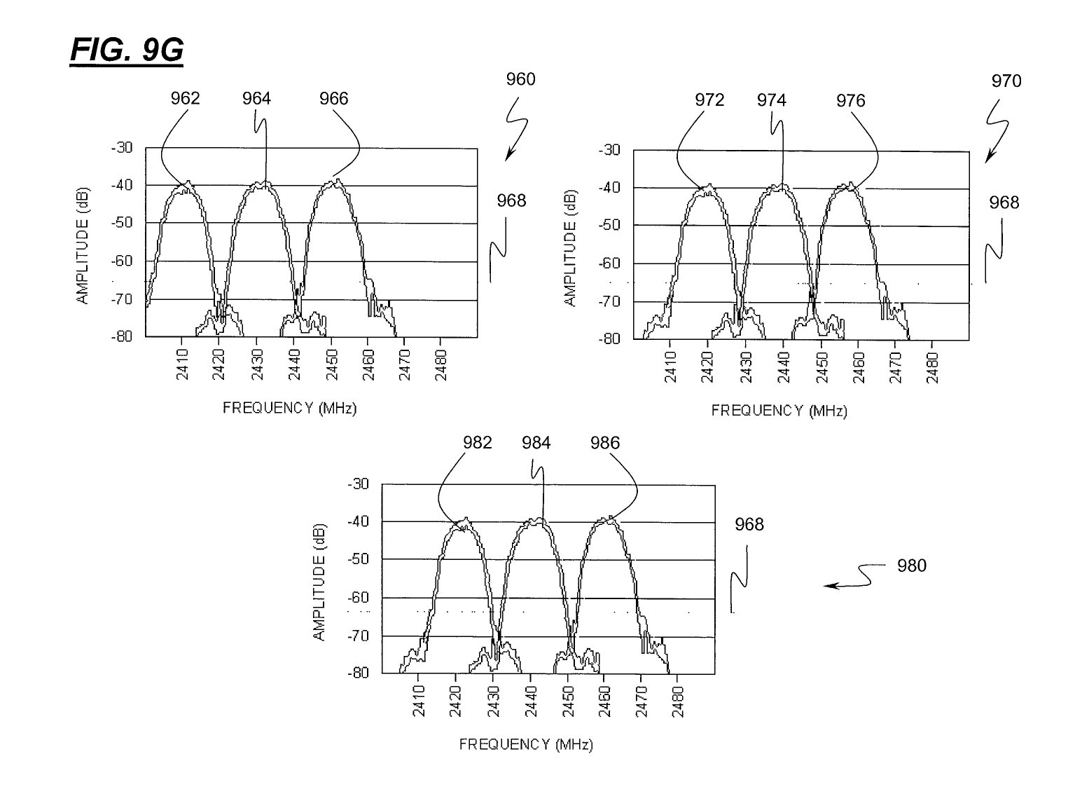

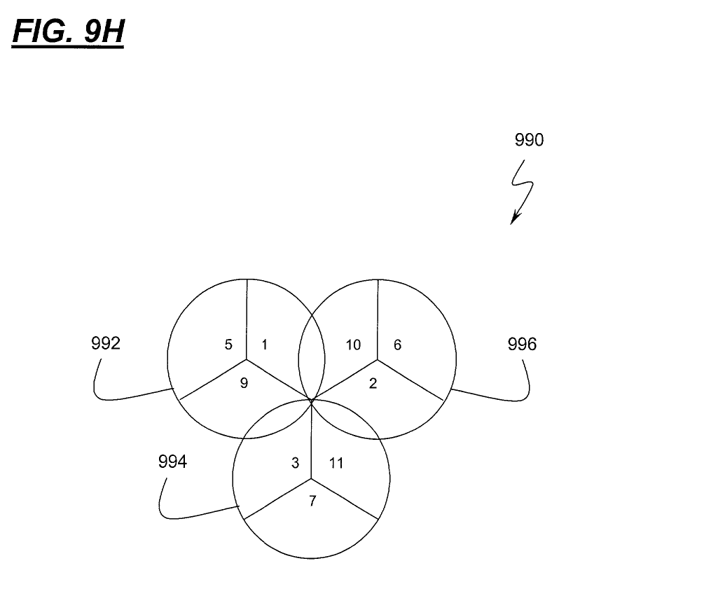

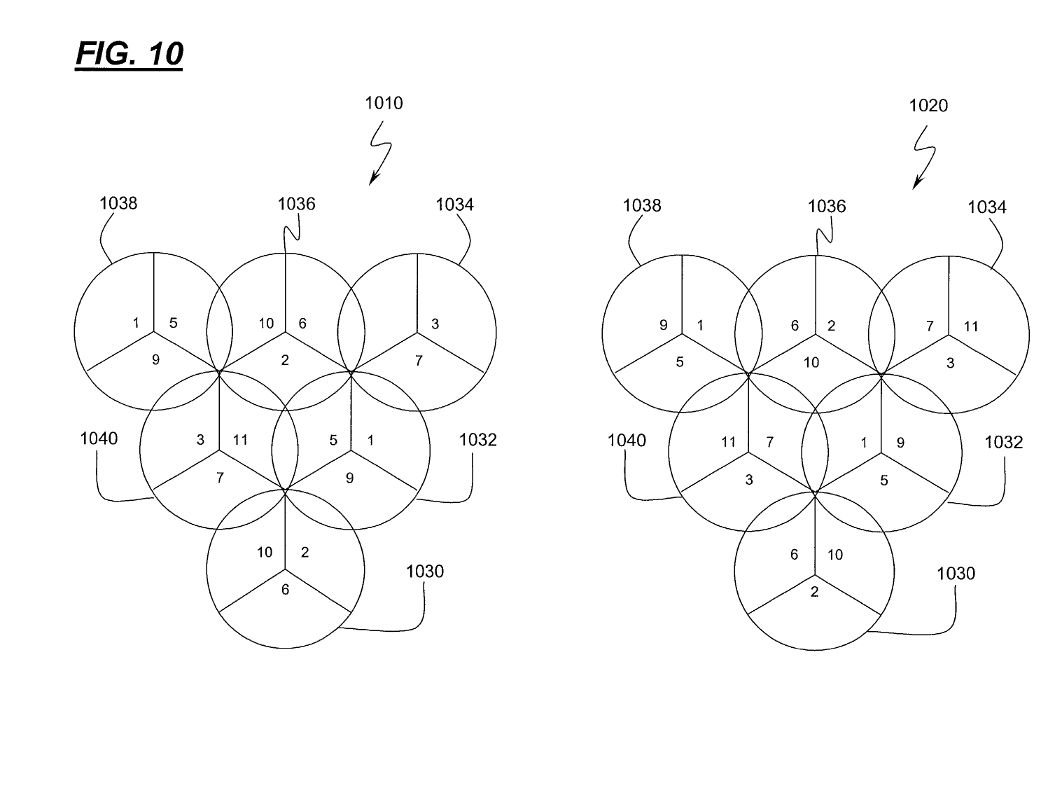

The RF channel filters 562, 564, 566 may be included for the purpose of deploying more densely populated cellular network topologies within a frequency spectrum, especially “public spectrum”, by virtue of increasing the number of non-contentious channel alternatives resulting from the significant diminishment of adjacent channel interference and co-channel intersymbol interference as illustrated in FIG. 9D and FIG. 9E below. Additionally, the RF channel filters 562, 564, 566 may be included for improving the overall transmission of the cell sectors 550, 555, 560 by improving the signal-to-noise (SNR) levels, thereby optimizing communication between a sector antenna 552, 554, 556 and a CPE device 170.

The power amplifiers 572, 574, 576 may be included to improve the RF signal strength for enhanced communications with a CPE device 170 over extended geographical distances. The insertion of a DC injection component (not shown) may be required if the power amplifiers 572, 574, 576 are to interface with a sector antenna 552, 554, 556 via a cable. The power amplifiers 572, 574, 576 in the preferred embodiment may be comprised of a pair of bi-directional circulators. The bi-directional feature improves the transmission sent from the sector antenna 552, 554, 556 to the CPE device 170, while also improving the transmission sent from the CPE device 170 to the sector antenna 552, 554, 556. Additionally, the power amplifiers 572, 574, 576 may also include an automatic gain control (AGC) feature. Automatic gain control allows for a fixed output of gain, usually measured in dBm. Inclusion of an AGC power amplifier between an access node 542, 544, 546, whose intentional radiator may emit an arbitrary level of gain, and a sector antenna 552, 554, 556 produces a fixed level of transmission gain. This feature allows for the open integration of access node devices that may emit a variety of gain levels within the intermediate frequencies while ensuring that the transmission of the cell sectors 550, 555, 560 complies with the specification requirements of spread spectrum operation.

The transmission cell 135 preferably includes three access nodes 542, 544, 546 that may operate using spread spectrum transmission such as an IEEE 802.11b (“Wi-Fi”) or IEEE 802.11a compliant access point (AP), for example. The access nodes 542, 544, 546 may transmit in a variety of modulations, including direct sequence spread spectrum (DSSS), frequency hopping spread spectrum (FHSS), Complementary Code Keying (CCK), and Orthogonal Frequency Division Multiplexing (OFDM). A modulation that makes use of phased-array antenna technology may also be included. The access nodes 542, 544, 546 may also employ a variety of media access controller configurations (MAC), including 802.11a, 802.11b, and 802.11g, for example. A MAC, such as an adaptive dynamic polling MAC, that may circumvent performance degradation issues inherent to CSMA/CA (Carrier Sense Multiple Access/Collision Avoidance) transmissions, such as the performance degradation attributed to “hidden nodes” within a spread spectrum environment, may also be included. The access nodes 542, 544, 546 are generally integrated with each corresponding cell sector and may interface with other elements of the cell via a data switch 516 or similar device. The access nodes are preferably connected to the data switch 516 via an ethernet link 510. The RF output of the access nodes 542, 544, 546, including the intermediate frequencies (IF frequencies), preferably interfaces with the components of the cell sectors 550, 555, 560 via a low-loss coaxial cable 580.

Additionally, the cell preferably includes a management element 518. The applications 520-534 of the management element 518 are preferably integrated into a single physical element and connected to a data switch 516 or similar device via an ethernet link. However, one or more of these applications 520-534 may operate independently as separate physical devices and may be connected to the data switch 516 via an Ethernet link. These applications 520-534 may be operationally regarded as “administrative” or “data flow” applications, for example. The applications 520-534 of the management element 518 preferably include a firewall 522, a cell management server (CMS) 524, a frequency optimization utility 526, an encryption method 528 or similar security protocol that includes certificate-based authentication through the usage of public keys at the IP layer, such as IPSec or Layer 2 Tunneling Protocol (LT2P), a DHCP server 530, a database component 532, and a cache server 534. The management element 518 preferably includes an operating system 520 that is preferably based upon an open-sourced platform such as Linux or FreeBSD. The management element 518 may also include other applications, such as applications that are commonly regarded as “administrative” or “data flow” applications, for example.

The firewall 522 preferably prevents the unauthorized routing of data traffic originating from external data networks of the data access system 100 through the transmission cell 135. The firewall 522 ensures that bi-directional data communication between the transmission cell 135 and the rest of the data access system 100, including data from the internet 125, conforms to specified security parameters.

The cell management server 524 preferably routes data traffic of the data access system 100. That is, it preferably targets the transmission of data traffic to its respective cell sectors 150, 155, 160 of CPE devices 170. This may aid in the precise routing and transmission of data traffic to CPE devices 170 of a particular cell sector 150, 155, 160, thereby improving the RF transmission efficiency and data performance of a given transmission cell 135. The cell management server 524 may also preferably employ restrictions pertaining to the operation or performance of a given CPE device 170, such as “traffic shaping” or “rate limiting.” That is, the cell management server 524 may preferably regulate the peak data rate for communication between the CPE device 170 and the transmission cell 135. Additionally, the cell management server 524 may preferably provision, authenticate, and manage a CPE device 170 of the data access system 100. For example, the cell management server 524 may query the database component 532 for verification of authentication records to compile subscriber configuration packets for CPE devices 170. The cell management server 524 may also preferably query the DHCP server 530 for compiling DHCP configuration packets of authorized CPE devices 170. The cell management server 524 may also preferably interface with a certificate-based encryption method 528, similar to the encryption method 1134 of the CPE device 170, for the purpose of transmitting a secure subscriber configuration packet to the CPE device 170, as well as for the secure bi-directional communication of data between the CPE device 170, the transmission cell 135 and other components of the data access system 100.

The frequency optimization utility 526 preferably allows the transmission cell 135 to dynamically optimize the transmission of one or more cell sectors 150, 155, 160. A preferred embodiment of the frequency optimization utility 526 is disclosed in FIG. 10 below.

The DHCP server 530, preferably via interface with the cell management server 524, preferably compiles the TCP/IP parameters of a given CPE device 170. These parameters preferably include the IP address, subnet mask and DNS server configuration for the CPE device 170.

The database component 532 preferably stores the active configuration and authentication parameters of a given CPE device 170. These parameters preferably include an IP address, routing configuration, DHCP configuration, DNS configuration, firewall configuration, operational restrictions, and the account status of an intended subscriber, if applicable. The database component 532 of the management comp may be updated

The cache server 534 preferably stores popular DNS records of the CPE devices 170, and selected DNS records of the data access system 100 at large. The DNS records resolved by the cache server 534 are consequently cached locally at the transmission cell 135, resulting in reduced data traffic across the transmission cell 135. This may improve the efficiency of the transmission cell 135 and provide an enhanced user experience for the intended subscriber of the data access system 100.

In operation, the transmission cell 135 transmits to and receives data from the data network via a cell data trunk 138 such as a modem 140 or other device for wired or wireless connectivity. The modem 140 may communicate with the transmission cell 135 through integration of the data switch 516 via an ethernet link 110. The data switch 516 interfaces with the spread spectrum access nodes 542, 544, 546. Data traffic passing bi-directionally through the access nodes 542, 544, 546 and the modem 140 via the data switch 516 may be managed and filtered using the applications 520-534 of the management element 518.

Data then passes from the RF output of the access nodes 542, 544, 546 to the power amplifiers 572, 574, 576, the RF channel filters 562, 564, 566, and then to the sector antennas 552, 554, 556 where the data may be transmitted to a CPE device 170.

The components that comprise the cell sectors 150, 155, 160 and the transmission cell 135 are preferably combined into a single, integrated package that may be quickly installed at a network cell site. Preferably, the sector antennas 150, 155, 160 provide 6 dBi to 12 dBi of gain, but may operate over a wide range of gain values that comply with the specification requirements of spread spectrum operation.

Although the preferred embodiment of the network transmission cell 135 includes three spread spectrum access nodes 542, 544, 546 and three sector antennas 552, 554, 556 providing three sectors 150, 155, 160 of transmission coverage per cell, a greater or lesser number of access nodes, cell sectors configurations, and antennas may be used.

Although the preferred embodiment of the cell sectors 150, 155, 160 of FIG. 5 illustrates the inclusion of a power amplifier 572, 574, 576 in a given transmission cell 135, a variance of power amplification deployments may be used within the given transmission cell 135 as an alternative embodiment of the cell sectors 150, 155, 160. For example, one of the cell sectors 150, 155, 160, such as RF sector 150, may require the inclusion of a power amplifier 572 to aid in circumventing potential RF transmission interference within the RF sector 150. Such interference may exist, for example, due to unfavorable terrain, such as dense foliage, that may be uniquely pervasive within the RF sector 150. In the given example, only one RF sector, namely RF sector 150, would require a power amplifier.

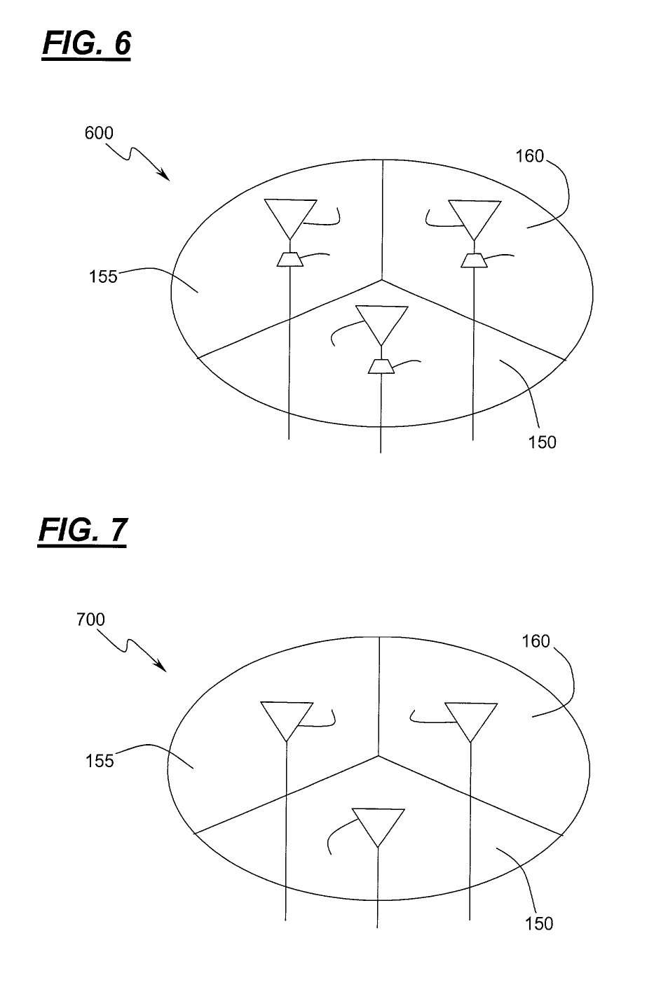

FIG. 6 illustrates an alternative preferred embodiment of the cell sectors 600 without a power amplifier according to the present invention. In some instances, a power amplifier 572, 574, 576 may occasionally be regarded as undesirable. In some operating environments, the power levels that such an amplifier emits may create adverse communication effects, such as an increased RF noise level and diminished signal-to-noise levels, thereby impeding optimal communication between a sector antenna 552, 554, 556 and a CPE device 170. A sector antenna 552, 554, 556 and a RF channel filter 562, 564, 566 are included.

FIG. 7 illustrates an alternative preferred embodiment of the cell sectors 700 without a power amplifier and RF channel filter according to the present invention. The exclusion of a power amplifier 572, 574, 576 is for the same intention as cited in FIG. 6. Under certain deployment scenarios, reduced channel separation resulting from the inclusion of an RF channel filter 562, 564, 566 as illustrated in FIG. 9G below may potentially be regarded as undesirable or unnecessary. For example, an instance may exist where a transmission cell 135 may not require the enhanced channel alternatives as afforded through the implementation of an RF channel filter 562, 564, 566. This scenario may be applicable in an instance where a singular transmission cell 135 is to function as the sole point of transmission within the data access solution 100. Given a single-cell RF topological deployment of the data access solution 100, potential interference resulting from the implementation of multiple RF cell topologies or other spread spectrum devices may not be applicable. A sector antenna 552, 554, 556 is included.

Preferably, the transmission cell 135 of the data access system 100 is as an element that is open and agnostic towards a variety of cell data trunks 138. That is, the transmission cell 125 may provide connectivity with a variety of cell data trunks 138. Consequently, an array of cell data trunks 138 may preferably be integrated within the data access system 100 for the purpose of establishing an amalgamated data network with pervasive wireless accessibility. Such an amalgamated data network may be managed from a single source, preferably via the network management server 105. Additionally, a homogenous CPE device 170 that exhibits a uniform configuration routine would preferably be issued to prospective network subscribers, regardless of the data trunk faction implemented at the transmission cell 135.

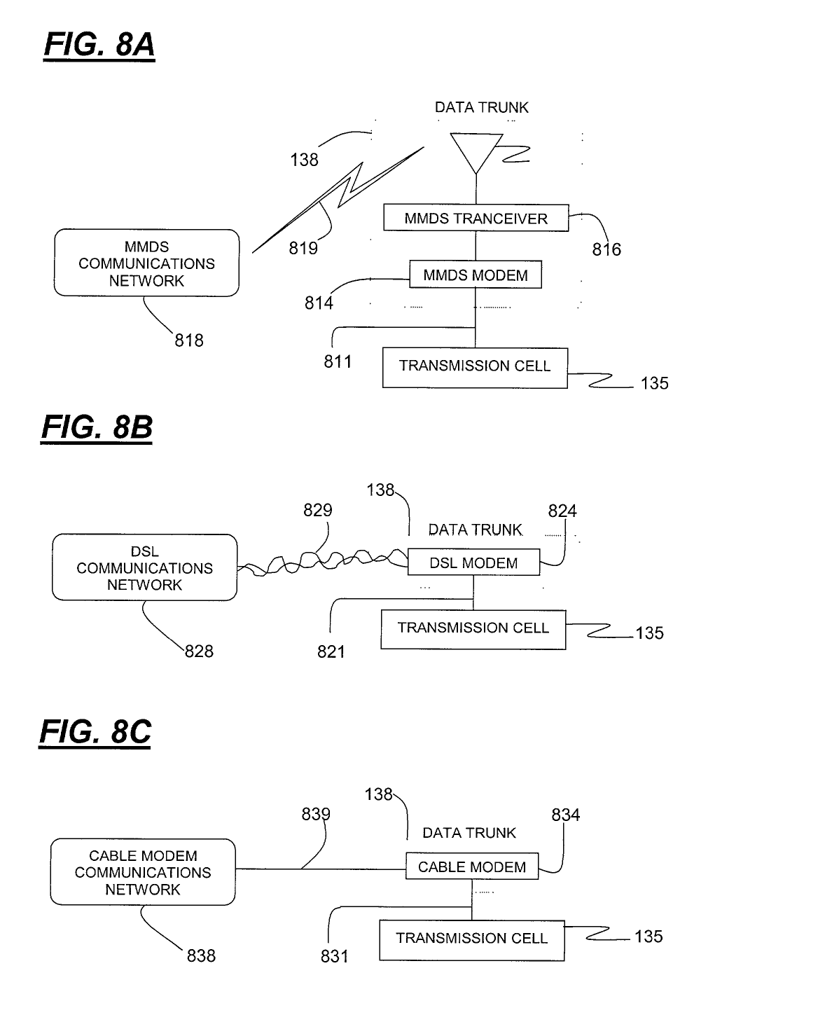

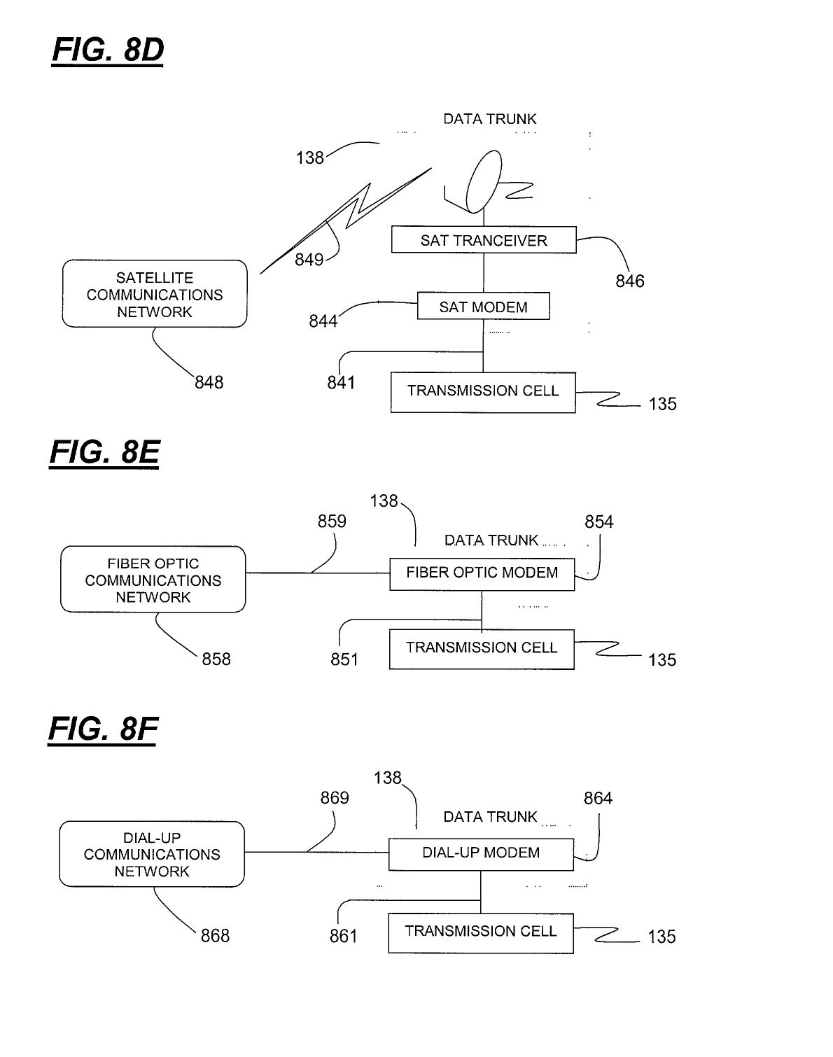

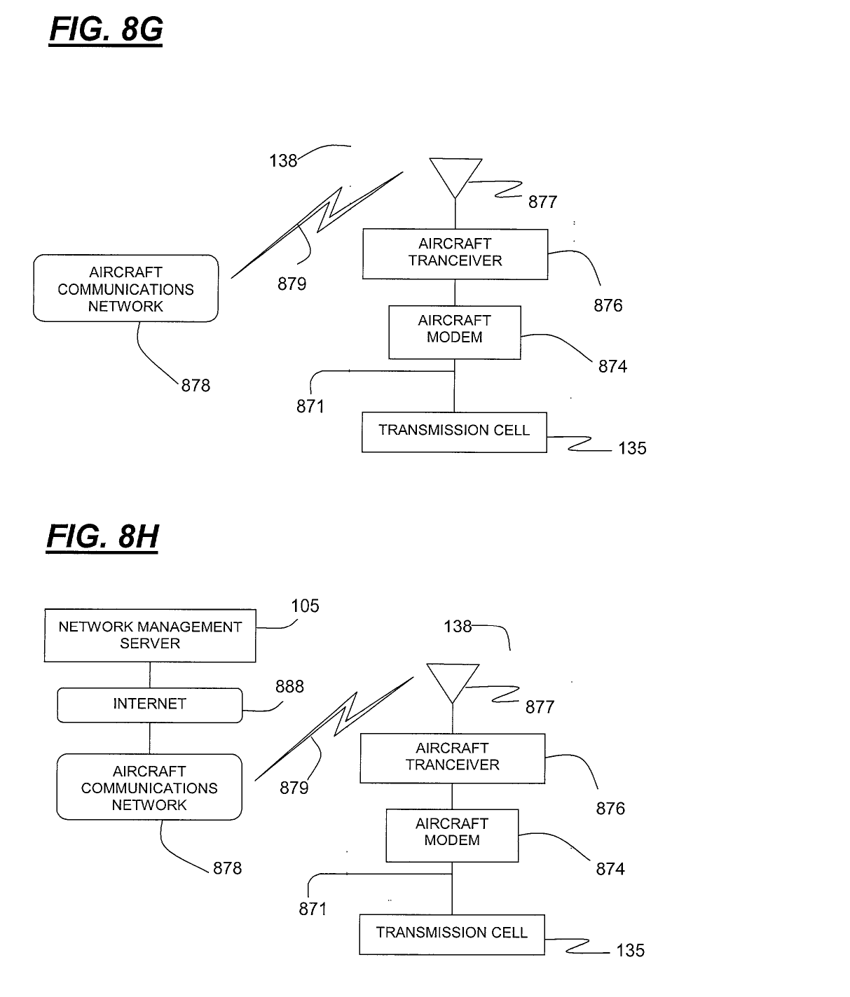

The integration of the transmission cell 135 of the data access system 100 with a variety of cell trunks is illustrated below in FIGS. 8A-F below.

FIG. 8A illustrates an alternative preferred embodiment of the cell data trunk 138 that is configured for use with an MMDS communications network 818 according to the present invention. A transmission cell 135 that is similar to the cell in FIG. 1 includes a cell data trunk 138 comprised of a wireless modem 814, and in particular an MMDS (or LMDS) modem for use with a wireless service that utilizes the MMDS frequencies or channels. The MMDS modem 814 may be coupled with a corresponding MMDS transceiver 816 and at least one MMDS antenna 817 for sending and receiving signals to an MMDS communications network 818. The MMDS modem 814 is preferably connected to the transmission cell 810 via an ethernet link 811. The MMDS modem may interface with a point-of-presence (POP) or network operations center (NOC) of the MMDS communications network 818 via MMDS signal transmission 819. Multiple MMDS modems 814 may be coupled to the transmission cell 810 for the purpose of increasing the bandwidth capacity of the data network serviced by the transmission cell 810. Additionally, other microwave frequencies, such as the 5 GHz Unlicensed National Information Infrastructure (UNII) frequencies, may be deployed as a data trunk in similar fashion using related devices.

FIG. 8B illustrates an alternative preferred embodiment of the cell data trunk 138 that is configured for use with a DSL communications network 828. The transmission cell 135 includes a data trunk 138 that is comprised of a DSL modem 824 for interfacing with a DSL communications network 828, which is typically comprised of standard twisted pair wiring. The DSL modem 824 is preferably connected to the transmission cell 820 via an ethernet link 821. The DSL modem 824 may interface with a POP or NOC of the DSL communications network 828 via a DSL communications line 829. Multiple DSL modems 824 may be coupled to the transmission cell 820 for the purpose of increasing the bandwidth capacity of the data network serviced by the transmission cell 820.

FIG. 8C illustrates an alternative preferred embodiment of the cell data trunk 138 that is configured for use with a cable modem communications network 838 according to the present invention. The transmission cell 135 includes a cell data trunk 138 comprised of a cable modem 834, such as a DOCSIS-compliant cable modem, for interfacing with a cable modem-based communications network 838, similar to those used by some providers such as cable TV companies to provide internet services or a coaxial cable-based data network. The cable modem 834 is preferably connected to the transmission cell 830 via an ethernet link 831. The cable modem 834 may interface with a POP or NOC of the cable modem communications network 838 via coaxial cable 839. Multiple cable modems 834 may be coupled to the transmission cell 831 for the purpose of increasing the bandwidth capacity of the data network serviced by the transmission cell 135.

FIG. 8D illustrates an alternative preferred embodiment of the cell data trunk 138 that is configured for use with a satellite communications network 848 according to the present invention. The transmission cell 135 includes a cell data trunk 138 that is comprised of a satellite modem 844 for use with a wireless service that utilizes satellite frequencies or channels. The satellite modem 844 may be coupled with a corresponding satellite transceiver 846, and at least one satellite antenna 847 or dish for sending and receiving signals to a satellite communications network 848. The satellite modem 844 is preferably connected to the transmission cell 840 via an ethernet link 841. The satellite modem 844 may interface with a POP or NOC of the satellite-based communications network 848 via satellite signal transmission 849. Multiple satellite modems 844 may be coupled to the transmission cell 840 for the purpose of increasing the bandwidth capacity of the data network serviced by the transmission cell 840.

FIG. 8E illustrates an alternative preferred embodiment of the cell data trunk 138 that is configured for use with a fiber optic communications network 858 according to the present invention. The transmission cell 135 includes a cell data trunk 138 that is comprised of a fiber-optic modem 854 for interfacing with a fiber-optic-based communications network 858. The fiber-optic modem 854 is preferably connected to the transmission cell 135 via an ethernet link 851. The fiber-optic modem 854 may interface with a POP or NOC of the fiber-optic communications network 858 via a fiber optic line 859. Multiple fiber-optic modems 854 may be coupled to the transmission cell 850 for the purpose of increasing the bandwidth capacity of the data network serviced by the transmission cell 850.

FIG. 8F illustrates an alternative preferred embodiment of the cell data trunk 138 that is configured for use with a dial-up communications network 868 according to the present invention. The transmission cell 135 includes a cell data trunk 138 comprised of a dial-up modem router 864, such as a modem device or router device that interfaces with a standard twisted pair wiring commonly used for telephone service (POTS), for interfacing with a dial-up-based communications network 868 such as the internet. The dial-up modem router 864 is preferably connected to the transmission cell 135 via an ethernet link 861. The modem router 864 may interface with a POP or NOC of the dialup-based communications network 868 via a telephone line 869. Multiple dial-up modem routers 864 may be coupled to the transmission cell 860 for the purpose of increasing the bandwidth capacity of the data network serviced by the transmission cell 860. Additionally, other telephony technologies, such as ISDN, may be deployed as a cell data trunk in similar fashion using related devices.

FIG. 8G illustrates an alternative preferred embodiment of the cell data trunk 138 that is configured for use with an aircraft communications network 878 or aircraft broadband communications network according to the present invention. A transmission cell 135 that is similar to the cell in FIG. 1 includes a cell data trunk 138 comprised of an aircraft modem 874 or other aircraft communication device for use with a wireless service that utilizes the frequencies or channels pertinent to aircraft data transmission. The aircraft modem 874 may be coupled with a corresponding aircraft transceiver 876 and at least one aircraft antenna 877 for sending and receiving signals to an aircraft communications network 878. The aircraft modem 874 is preferably connected to the transmission cell 135 via an ethernet link 871. The aircraft modem may interface with a point-of-presence (POP) or network operations center (NOC) of the aircraft communications network 878 via aircraft signal transmission 879. Multiple aircraft modems 874 may be coupled to the transmission cell 135 for the purpose of increasing the bandwidth capacity of the data network serviced by the transmission cell 135.

FIG. 8H illustrates an alternative preferred embodiment of the cell data trunk 138 that is configured for use with an aircraft communications network 878 or aircraft broadband communications network and is managed by the network management server 105 via the internet 888 according to the present invention. A transmission cell 135 that is similar to the cell in FIG. 1 includes a cell data trunk 138 comprised of an aircraft modem 874 for use with a wireless service that utilizes the frequencies or channels pertinent to aircraft data transmission. The aircraft modem 874 may be coupled with a corresponding aircraft transceiver 876 and at least one aircraft antenna 877 for sending and receiving signals to an aircraft communications network 878. The aircraft modem 874 is preferably connected to the transmission cell 135 via an ethernet link 871. The aircraft modem may interface with the internet 888 via aircraft signal transmission 879. Multiple aircraft modems 874 may be coupled to the transmission cell 135 for the purpose of increasing the bandwidth capacity of the data network serviced by the transmission cell 135.

Many spread spectrums standards, especially the standards that relate to transmission in the 2.4 GHz ISM or 5 GHz Unlicensed National Information Infrastructure (UNII) frequencies, do not address the substantial limitations of transmitting multiple channels or frequencies from a single location, such as the transmission cell 135 of FIG. 1.

FIG. 9A includes a table 900 of a preferred embodiment of a segmentation of the United States FCC-authorized spread spectrum frequencies within the 2.4 GHz Industrial Scientific and Medical (ISM) frequency range. The preferred segmentation identifies eleven channel centers exhibiting 5 MHz of channel separation.

Channel separation is required of some spread spectrum components, especially direct sequence spread spectrum (DSSS) components, for operation at an optimal data rate per charnel. For example, many DSSS devices typically require channel separation as much as 25 MHz (that is, five channels) to effectively transmit at an optimal data rate, such as 11 mbps or 54 mbps, per channel.

As detailed in FIGS. 9A-H, one aspect of the preferred embodiment is the implementation of high-resolution channel filtering. By implementing high-resolution channel filtering, the channel spacing may be decreased and the preferred 11 frequency channels shown in FIG. 9A may be obtained. The preferred channel spacing provides three sets of three channels as well as two additional channels as described below.

FIG. 9B illustrates three spread spectrum waveforms 912, 914, 916 within a direct sequence environment that include a frequency plan 910 comprised of three discreet carriers according to the present invention. The waveforms 912, 914, 916 exemplify channel center frequencies transmitting at 2412 MHz, 2437 MHz, and 2462 MHz, corresponding to channel one, channel six, and channel eleven of FIG. 9A, respectively. The waveforms 912, 914, 916 maintain approximately 25 MHz of requisite channel separation as described above. The noise floor 918 generated by the transmitted waveforms 912, 914, 916 is comparatively low and does not meaningfully contribute towards channel interference.

Within many spread spectrum environments, especially direct sequence environments, the frequency plan resulting from a requisite 25 MHz of channel separation yields a restricted cellular network topology that may only include transmission cells 135 exclusively transmitting channel one, channel six, and channel eleven as referenced in the waveforms of FIG. 9B.

FIG. 9C illustrates a standard spread spectrum cellular network topology 920 within a direct sequence environment according to the present invention. In this example, the cellular network topology 920 is comprised of three exemplary cells 922-926. Each of the exemplary cells 922-926 includes a finite frequency plan exhibiting the requisite 25 MHz of channel separation described above. The frequency plan corresponds to channel one, channel six, and channel eleven of FIG. 9A, respectively. The ability to deploy densely populated frequency plans that transmit at a maximum specified data rate per sector is consequently restricted due to the inherently limited number of non-contentious channel alternatives.

FIG. 9D illustrates spread spectrum waveforms 932, 934, 936 within a direct sequence environment that comprise a frequency plan 930 of three carriers that exhibit adjacent channel interference. Adjacent channel interference occurs when the sidebands 938 of a transmitted carrier overlap into an adjacent channel. For example, the sidebands 938 overlap considerably in the illustrated waveforms 932, 934, 936 which exemplify the transmission of channel center frequencies 922, 924, 926 at 2412 MHz, 2427 MHz, and 2442 MHz corresponding to channel one, channel four, and channel seven of FIG. 9A, respectively. The resulting adjacent channel interference generates an elevated noise floor 929. The increased noise floor 929 reduces the sensitivity of the communication of the transmission cell 135 to the extent that its transmission coverage area may be significantly reduced. Additionally, when an adjacent carrier is transmitting within 10 MHz or less (that is, two or less channels) of another transmitted channel, communication of both carriers is compromised to the extent that demodulation of their respective RF transmissions may no longer be possible.

FIG. 9E illustrates spread spectrum waveforms 940 within a direct sequence environment that exhibit co-channel intersymbol interference. Co-channel intersymbol interference occurs when two digital carriers coexist on identical frequencies. For example, the illustrated waveform 940 exemplifies the simultaneous transmission of two identical channel center frequencies 942, 944 at 2432 MHz, each corresponding to channel five of FIG. 9A above. Both signals are valid digital carriers and require error correction to demodulate the RF transmission. However, the desired-to-undesired carrier-to-noise (C/N) ratio of the digital carriers illustrated in the waveforms 940 generates unacceptable RF interference. The C/N ratio of one digital carrier must be roughly 10 dB greater than another digital carrier before they no longer interfere with one another to achieve successful demodulation of the RF frequency.

To circumvent these inherent RF limitations, the data access solution 100 may benefit from filtering the RF transmission of a spread spectrum transmission cell 135, for the purpose of increasing the reliability of communication with a device, such as the CPE device 170. For example, filtering may improve the signal-to-noise rations (SNR) of the CPE device 170.

Additionally, RF filtering may contribute to the deployment of additional frequency plans within spread spectrum, especially direct sequence spread spectrum, by refining the sidebands of the channel waveforms without compromising transmission bandwidth. For example, filtering may permit channel separation as close as 15 MHz (that is, three channels) in adjacent cell sectors while significantly diminishing the occurrence of adjacent channel interference and co-channel intersymbol interference. This results in the ability to deploy densely populated frequency plans that transmit at an optimal data rate per RF sector 150, 155, 160 by significantly increasing the number of non-contentious channel alternatives. This may aid in the deployment of a more densely populated cellular network topology, especially if the data network transmits using “public spectrum.”

FIG. 9F illustrates a preferred embodiment of an enhanced spread spectrum waveform 950 within a direct sequence environment that is achieved through the deployment of RF filtering according to the present invention. The enhanced waveform 950 exemplifies a filtered channel frequency of 2432 MHz corresponding to channel five of FIG. 9A. The sidebands 952 of the transmitted channel are significantly refined, radically diminishing the probability of interference with adjacent channels. Additionally, the enhanced waveform 950 may allow the transmission cell 135 to transmit at an optimal data rate per RF sector 150, 155, 160, employing a channel separation that is significantly less than what would typically be required of a given spread spectrum frequency. This results in the capability of the transmission cell 135 to transmit using channels that are closer together while restricting the incidence of interference, especially adjacent channel interference and co-channel intersymbol interference illustrated in FIG. 9C and FIG. 9D, respectively.

FIG. 9G illustrates a preferred embodiment of additional spread spectrum frequency plans 960, 970, 980 within a direct sequence environment afforded by the implementation of RF channel filtering according to the present invention. The filtered frequency plans 960, 970, 980 illustrate channel separation of 20 MHz. The waveforms 962, 964, 966 of the first frequency plan 960 exemplify center frequencies transmitting at 2412 MHz, 2432 MHz, and 2452 MHz, corresponding to channel one, channel five, and channel nine of FIG. 9A, respectively. The waveforms 972, 974, 976 of the second frequency plan 970 exemplify center frequencies transmitting at 2417 MHz, 2437 MHz, and 2457 MHz, corresponding to channel two, channel six, and channel ten. The waveforms 982, 984, 986 of the third frequency plan 980 exemplify center frequencies transmitting at 2422 MHz, 2442 MHz, and 2462 MHz, corresponding to channel three, channel seven, and channel eleven. The relatively low noise floor 968 realized by filtering the waveforms of the filtered frequency plans 960, 970, 980 may allow the transmission cell 135 to transmit at an optimal data rate per RF sector 150, 155, 160. Note that in this example, channels four and eight are not be utilized and consequently may be used in place of a contested channel within a cell sector for a given cellular network topology.

FIG. 9H illustrates a preferred embodiment of an enhanced spread spectrum cellular network topology 990 within a direct sequence environment derived from the employment of RF filtering according to the present invention. In this example, the cellular network topology 990 is comprised of three exemplary cells 992-996. Each of the exemplary cells 992-996 includes a unique frequency plan exhibiting 20 MHz of filtered channel separation as illustrated in FIG. 9G.

The enhanced cellular network topology 990 of FIG. 9H may be distinguished from the standard network topology 940 of FIG. 9C by virtue of the two additional non-contested frequency plans afforded by filtering the sidebands of the waveforms to 20 MHz of channel separation as described above.

Additional frequency plans may be achieved by filtering the channel separation to a greater or lesser degree. For example, filtering the channel centers to 15 MHz may yield a three-sector frequency plan with four possible alternatives. This would effectively provide a cellular network topology exhibiting minimal channel interference that may collectively transmit at an optimal data rate per RF sector using channels one, four and seven, another using channels two five and eight, another using channels three six and nine, and another using channels four, seven and ten.

A frequency optimization utility may allow the data access system 100 to dynamically automate the frequency optimization of one or more cell sectors 150, 155, 160 by determining the most effective cellular network topology for the purpose of minimizing external or internal interference, maximizing the collective signal-to-noise ratios between the transmission cells 135 and the CPE devices 170, and enhancing overall performance of the data access system 100.

FIG. 10 illustrates a preferred embodiment of a frequency optimization utility according to the present invention. FIG. 10 illustrates two cellular network topologies, an original cellular network topology 1010 and an optimized cellular network topology 1020. Each cellular network topology 1010, 1020 includes six exemplary cells 1030-1040. The cellular network topology 1010, 1020 is shown with six cells for exemplary purposes only and is not limited to six cells. Each of the exemplary cells 1030-1040 includes three cell similar to the cell sectors 150, 155, 160 of FIG. 1.

Some spread spectrum cellular transmission, for example, within the 2400 MHz-2483 MHz frequencies and the 5 GHz frequencies takes place in spectrum allocated as “public spectrum.” Consequently, such cellular transmissions may be susceptible to interference from other spread spectrum devices residing in the same cell sector and transmitting in an identical or adjacent channel. Under such conditions, a typical resolution may be for the interfering party to adjust its existing transmit channel to a frequency that no longer generates mutual contention. In the case of Direct Sequence Spread Spectrum (DSSS) devices, this involves the selection of a channel at least 10 MHz apart (that is, two channels apart) from the co-channel or adjacent channel in question.

Preferably, each of the exemplary cells in FIG. 10 transmits the maximum allowable dBm power level as specified for acceptable operation. Consequently, in the majority of instances where adjacent channel interference or co-channel intersymbol interference occurs, only the performance of the lower-powered device of the conflicting party would be adversely affected, and not the exemplary cells 1030-1040. Such low-power devices are typically utilized for indoor commercial applications and inherently maintain a localized range of transmission, usually 500 to 1500 feet in omni-directional deployment.

The typical immediate resolution would result in the party with the lower-powered device manually changing its channel frequency to a frequency that no longer conflicts with the exemplary cells 1030-1040 in that sector.

Atypically, a situation may transpire when another party transmits within perhaps 15 MHz of an exemplary cell 1030-1040 sector channel at an excessive power level that generates significant RF contention within that cell sector. This potentially results in degraded RF transmission of the exemplary cells 1030-1040 to one or more CPE devices 170 within the sector, as the signal-to-noise ratios may be degraded by virtue of adjacent channel interference or co-channel intersymbol interference. Although the operability of both parties' devices may be mutually diminished, the exemplary cells 1030-1040 may employ a frequency optimization utility to maintain unaffected transmission capability.

The implementation of a frequency optimization utility may radically diminish the occurrence of adjacent channel interference and co-channel intersymbol interference generated from the existence of other high-power devices residing in the same cell sectors. The automated deployment of a frequency optimization utility may detect and characterize such contention. A frequency optimization utility may generate a revised frequency plan that collectively optimizes RF propagation to CPE devices 170 throughout the data access system 100.

In operation, a preferred embodiment of the frequency optimization utility according to the present invention may interact with the frequency optimization utility of one or more CPE devices 170 and may perform aggregate assessment of signal-to-noise ratios for CPE devices 170 within the cell sectors 150, 155, 160 of the data access system 100. Preferably, at timed intervals that may be specified in the configuration parameters of the frequency optimization utility, the frequency optimization utility may “poll” the collective signal-to-noise ratios of one or more CPE devices 170 of the transmission cell sectors 150, 155, 160. If, for example, the cumulative average of the detected signal-to-noise ratios of one or more CPE devices 170 within a sector, for example sector 150 of FIG 1, has diminished by a value as specified within the configuration parameters of the frequency optimization utility, the frequency optimization utility may acknowledge the interference and select a different channel, preferably 15 MHz-25 MHz in variance, that does not conflict with the contentious device. Consequently, the channels of the remaining two sectors, for example sectors 155, 160, may be changed by virtue of implementing a revised frequency plan for the transmission cell 135. The utility may also employ the reconfiguration of other adjacent cells of the data access system 100 as a result of changing the frequency pattern of a single transmission cell 135, as further described below.

In FIG. 10, for example, the cellular network topology 1010 illustrates the exemplary cells 1030-1040 utilizing frequency plans resulting from the integration of RF channel filter components 562, 564, 566 that have refined the transmitted sectors to 20 MHz of channel separation as characterized in FIG. 10G. The sector transmitting on channel 11 of the northernmost exemplary cell 1034 (highlighted in gray), for example, is experiencing high-power adjacent channel interference or co-channel intersymbol interference. The frequency optimization utility may then register a significant aggregate decrease in the collective signal-to-noise ratios of the CPE devices 170 residing in that specific cell sector. The frequency optimization utility of the exemplary cell 1034 may then attempt to optimize the exemplary cell 1034 by selecting channel 7, which is a non-contested channel. This action effectively rotates the channel plan of the exemplary cell 1034 by 120 degrees in a clockwise direction as shown in the optimized cellular network topology 1020.

In the optimized cellular network topology 1020, because exemplary cell 1034 has been rotated, the frequency plan of the other exemplary cells 1030-1040 may also be adjusted. That is, the exemplary cell 1030 is rotated 120 degrees in a clockwise direction, the adjacent exemplary cell 1032 is rotated 120 degrees in a counter-clockwise direction, the adjacent exemplary cell 1036 is rotated 120 degrees in a counter-clockwise direction, the exemplary cell 1038 is rotated 120 degrees in a clockwise direction, and the exemplary cell 1040 is rotated 120 degrees in a counter-clockwise direction.

If, when implemented, the optimized cellular network topology 1020 inadvertently induces frequency contention of another exemplary cell, for example the sector containing channel 11 of the exemplary cell 1040, the optimized cellular network topology 1020 may then be subsequently adjusted by rotation of the cells another 120 degrees in a similar manner.

Note that adjacent channel interference and co-channel intersymbol interference is not present to any substantial degree within any incarnation of the optimized cellular topology 1020. That is, the subsequent rotations of the cellular network topology do not induce interference among the cells.

The flexibility of the spread spectrum implementation permits dynamic and instantaneous channel switching of each CPE device 170 residing in its respective sectors 150, 155, 160 of the transmission cell 135 in accordance with the revised frequency plan as directed by the frequency optimization utility. All original configurations of the data access system 100, in particular the original configurations of the CPE devices 170 such as DHCP and user authentication, may remain unaltered within each sector.

An alternative embodiment of the frequency optimization utility according to the present invention may be to substitute an affected cell with an alternate frequency plan or substitute an affected sector with an alternate channel, leaving the adjacent cells of a cellular network topology unaffected.

For example, the exemplary cell 1034 of the cellular network topology 1020 may experience high-power adjacent channel interference or co-channel intersymbol interference as described above. The frequency optimization utility may then elect to substitute a frequency plan of channel ten, channel six, and channel two (revised from channel eleven, channel seven, and channel three, respectively). The other exemplary cells 1030-1040 of the cellular network topology 1010 would remain unaffected.

Alternatively, the frequency optimization utility may substitute an affected RF sector 150, 155, 160 of a transmission cell 135 with a channel that does not interfere with adjacent cell sectors or the transmission of adjacent cells. For example, exemplary cell 1034 of the cellular network topology 1010 above may experience high-power adjacent channel interference or co-channel intersymbol interference in the RF sector that actively transmits on channel three. The frequency optimization utility may then elect to substitute channel three with a non-contested channel that maintains a minimum 15 MHz channel separation, such as channel one, channel two, or channel four. The other exemplary cells 1030-1040 of the cellular network topology 1010 would remain unaffected.

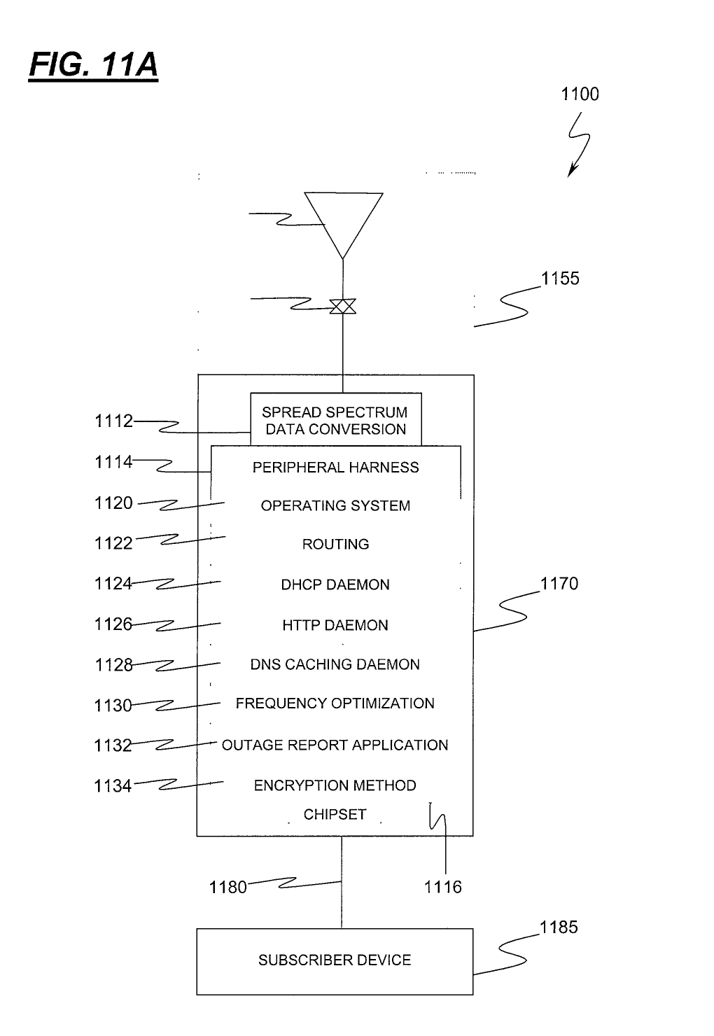

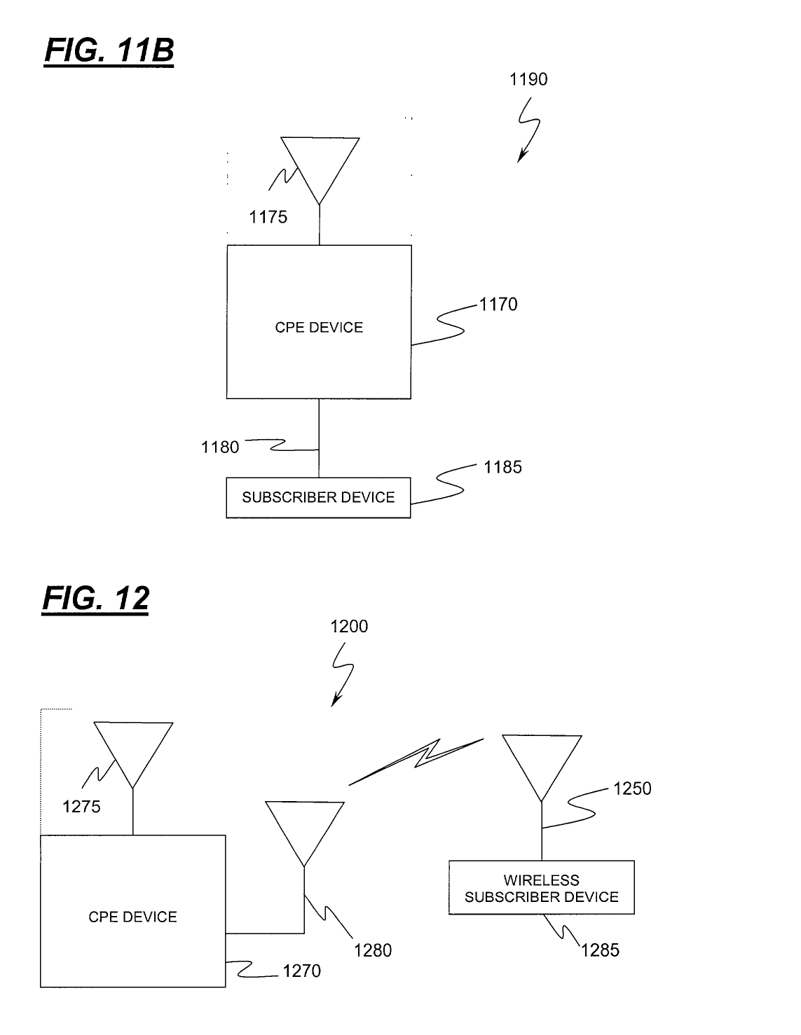

FIG. 11A illustrates an expanded functional view 1100 of the CPE device 170 of FIG. 1 according to a preferred embodiment of the present invention. Generally speaking, the CPE device 170 preferably includes a wireless transceiver 1175, such as a spread spectrum antenna or similar device that may be commonly regarded as an intentional radiator. The wireless transceiver 1175 preferably employs a circular RF polarization pattern.

A preferred embodiment of the CPE device 170 according to the present invention may also include a power amplifier 1110 or booster in the wireless transceiver 1175. The power amplifier 1110 maybe comprised of a pair of bi-directional circulators. The bi-directional feature improves the transmission sent from the CPE device 170 to the sector antenna 552, 554, 556 of a transmission cell 135, while also improving the transmission sent from the transmission cell 135 to the CPE device 170. Additionally, the power amplifier 1110 may also include an automatic gain control (AGC) feature. Automatic gain control allows for a fixed output of gain, usually measured in dBm. Inclusion of an AGC power amplifier between the spectrum data conversion component 1112 of the CPE device 170, whose intentional radiator may emit an arbitrary level of gain, and the wireless transceiver 175 produces a fixed level of transmission gain. This feature allows for the open integration of spread spectrum data conversion components that may emit a variety of gain levels within the intermediate frequencies while ensuring that the transmission of the CPE device 170 complies with the specification requirements of spread spectrum operation

The collective functionality of an antenna and power amplifier 1110 and a wireless transceiver 1175 may physically exist as a single, integrated component or operate independently as separate devices. Preferably, the wireless transceiver 1175 and power amplifier 1110 may be housed within an extended casing 1155 of the CPE device 170 and the integrated unit may be commercially regarded as an “indoor” device. Alternatively, the wireless transceiver 1175 and power amplifier 1110 may interface with the components of the CPE device 170 as separate units via a low-loss coaxial cable (not shown). The insertion of a DC injection component (not shown) may be required if the power amplifier 1110 is to interface with the CPE device 170 via a cable such as a low-loss coaxial cable.

The CPE device 170 may be attached to a multitude of subscriber devices 1185 such as a personal computer (PC) or other network device such as a data switch or hub (not shown) via the communication link 1180. The communication link 1180 is preferably an ethernet communication link, a USB communication link, or an IEEE 1394 FireWire communication link, for example.

Additionally, the CPE device 170 includes a chipset 1116 such as a PC104 chipset or similar component that may be regarded as a single board computer (SBC) that preferably supports a central processing unit (CPU), such as Intel, AMD, Motorola or ARM microprocessors. Preferably, the CPE device 170 also includes a chipset 1116 that may accommodate at least ten megabytes of flash memory storage and sixteen to thirty-two megabytes of RAM. The CPE device 170 may include a greater or lesser number of flash memory storage and RAM.

In operation, the RF output of the power amplifier 1110 may be converted to a useable data format, such as IP-based ethernet, for use by the chipset 1116. This may be accomplished via a spread spectrum data conversion component 1112 such as a spread spectrum transceiver, radio modem, or similar device. The spread spectrum data conversion component may take the form of a PCMCIA (Personal Computer Memory Card/International Association), or Compact Flash (CF), which may be connected to the chipset 1116 through a compatible peripheral harness 1114.

An alternative preferred embodiment of the CPE device 170 may include the spread spectrum data conversion component 1112 as an integrated element within the circuitry of the chipset 1116.

Additionally, the CPE device 170 preferably includes applications 1120-1134 commonly regarded as “attendant” applications. These applications 1120-1134 are preferably integrated into the flash memory storage and RAM of the chipset 1116. The applications include a routing application 1122, a DHCP daemon application 1124, an HTTP daemon 1126 that is preferably SSL-compliant, a DNS caching daemon application 1128, a frequency optimization utility 1130, a pervasive outage reporting application 1132 and a certificate-based encryption method 1134 or similar security protocol that includes certificate-based authentication through the usage of public keys at the IP layer, such as IPSec or Layer 2 Tunneling Protocol (LT2P). The CPE device 170 preferably also includes an operating system 1120 that is preferably based upon an open-sourced platform such as Linux or FreeBSD. The operating system 1120 is preferably integrated into the flash memory storage of the chipset 1116. The CPE device 170 may also include other applications commonly regarded as “attendant” applications.

In operation, the routing capabilities inherent to the routing application 1122, such as that which may be found, for example, in a Linux Kernel or FreeBSD compilation, may act as a basic bridge to a single subscriber device 185 such as a personal computer or, alternatively, may act as a functional router for a sizeable local area network (LAN). The operating system 1120 preferably provides the base routing capabilities of the CPE device 170

Additionally, the routing application 1122 preferably includes an IP masquerade feature. IP masquerading allows any subscriber device 185, such as a personal computer or data switch, that is connected to the CPE device 170 to appear as the IP address of the CPE device 170 itself. The assignment of a masqueraded IP to a subscriber device 185 by the CPE device 170 renders the malicious compromise of network service, network data, and impersonation of authorized network subscribers exceedingly more difficult. Thus, IP masquerading provides a level of security several orders of magnitude higher than most broadband routing options, such as those found in the DOCSIS (data over cable service interface specification) standard. Because the CPE device 170 supports IP masquerading, the CPE device 170 may be seamlessly integrated into a pre-existing subscriber network such as a LAN.

Additionally, the routing configuration of the CPE device 170 may be managed either by the administrator of the data access system 100 or the intended subscriber of the CPE device 170, at the administrator's option. Permitting the routing configuration of the CPE device to be controlled by the administrator of the data access system 100 would offer the administrator the ability to limit the number of subscriber devices 185 that may be connected to a single CPE device 170. Management of the routing configuration by the subscriber would give control to the subscriber with respect to the integration of the CPE device 170 within a commercial network environment, without the need for additional hardware.

The routing application 1122 may provide comprehensive statistical data reporting in regard to the performance of the CPE device 170 as well as the performance of the data access system 100. The intended subscriber using the CPE device 170 may access network performance data that is preferably presented in a web-based format that is generated by the HTTP daemon application 1126. The routing application may also exchange information with the network management server 105 and the management element 518 of the transmission cell 135. As a result, the routing application 1122 may also contribute to providing the administrator of a data access system 100 with comprehensive statistical data such as overall performance or network congestion. This data is preferably presented in a web-based format and accessed via an HTTP query to the HTTP daemon 230 of the network management server 105.

At the option of the administrator of the data access system 100, the routing application 1122 may also employ transparent HTTP caching. Transparent HTTP caching may permit all subscriber devices 185 connected to the CPE device 170 to retrieve cached data content residing on the cache server 534 of the corresponding transmission cell 135 without having to configure the intended subscriber's web browser application.

The DHCP daemon application 1124 preferably allows one or more subscriber devices 185 of an intended subscriber to be automatically configured for use with the CPE device 170. The DHCP daemon application 1124 configuration may be provided by the cell management server 524 via interface with the DHCP server 530 within the management element 518 of the transmission cell 135 mentioned above, giving the administrator of the data access system 100 control of the network information sent by the DHCP daemon application 1124.

The HTTP daemon application 1126 performs the initial provisioning of the CPE device 170 which may then be completed by the intended subscriber. Subsequent to configuration of the CPE device 170, the HTTP daemon application 1126 may assist in providing account information to the intended subscriber. Additionally, the HTTP daemon application 1126 may also generate selected operational statistics of the CPE device 170, thus permitting a degree of troubleshooting by the intended subscriber. The HTTP daemon application 1126 may also generate a cache server auto-configuration file if the transparent caching feature of the routing application 1122 has been disabled or is not present.

The DNS caching daemon application 1128 may be accessible to all subscriber devices 1185 connected to the CPE device 170. DNS records resolved by the DNS caching daemon application 1128 may be cached locally on the CPE device 170, which may result in reduced data traffic across the transmission cell 135. This may improve the efficiency of the transmission cell 135, and provide an enhanced user experience for the intended subscriber of the data access system 100.

The preferred embodiment of the frequency optimization utility 1130 functions as an integrated application that operates in concert with a frequency optimization utility 526 of the transmission cell 135 and relays transmission information, such as signal-to-noise ratios or data transmission performance, of the CPE device 170 within the corresponding cell sectors 150, 155, 160 of the data access system 100. The relay of such information to the frequency optimization utility 526 of the transmission cell 135 is preferably at timed intervals that may be specified in the configuration parameters of the 526 utility of the transmission cell 135 and the frequency optimization utility 1130 of the CPE device 170. The implementation of a frequency optimization utility 1130 may radically diminish the occurrence of adjacent channel interference and co-channel intersymbol interference generated from the existence of other high-power devices residing in the same cell sectors 150, 155, 160 as the CPE device 170.

The pervasive outage reporting application 1132, in conjunction with the HTTP daemon application 1126, may be configured to generate a message, preferably a message in a web browser application during an outbound HTTP query, in the event of an outage within the data access system 100. For example, an outage in the ability of the CPE device 170 within the data access system 100 to interface with the internet 125. The outage message may provide the intended subscriber with information stating the reason for the outage, related news, and an expected ETA for the reestablishment of a service. Once the intended subscriber acknowledges the message, the message can be deleted, and the intended subscriber returned to normal, though not completely functional, operation. By implementing a pervasive outage reporting application 1132 at the level of the CPE device 170, an outage notification can be sent even if the customer has no connectivity to the cell.

The certificate-based encryption method 1134 interfaces with a similar encryption method 528 of the cell management server 524 for the purpose of transmitting a secure subscriber configuration packet to the CPE device 170, as well as for the secure bi-directional communication of data between the CPE device 170, the transmission cell 135, and other components of the data access system 100.

Alternatively, the applications 1120-1134 of the CPE device 170 may exist as a single software application that may be installed via peripheral disk media onto a subscriber device 185, such as a personal computer. The applications 1120-1134 may also be acquired and installed onto a subscriber device 185 via the internet, a WAN, or LAN. Additionally, the wireless transceiver 175 may exist as an integrated element of a subscriber device 185. That is, a subscriber device 185 may initially include an element within its operational scope that may qualify as a compatible spread spectrum wireless transceiver 175 according to the present invention.

FIG. 11B illustrates an alternative preferred embodiment 1190 of the CPE device 170 without a power amplifier 1110 according to the present invention. In some instances, a power amplifier, such as the power amplifier included in the preferred embodiment of FIG. 11A, may potentially be regarded as undesirable. The power levels that such an amplifier emits may create adverse communication effects, such as an increased RF noise level and diminished signal-to-noise levels, thereby impeding optimal communication between the CPE device 170 and a sector antenna 552, 554, 556 within one of the designated cell sectors 150, 155, 160.

Additionally, the communication link 180 of the CPE device 170 may exist as a wireless communication link that communicates with a compatible wireless subscriber device in the manner of a wireless data repeater, bridge or router as illustrated in FIG. 12 below. This wireless subscriber device preferably includes a spread spectrum radio in any of a variety of forms such as a PCMCIA card or Compact Flash (CF) card or a spread spectrum transmission component integrated within a device such as a personal computer, handheld device, or peripheral device. The communication environment between the wireless communication link of the CPE device 170 and one or more wireless subscriber devices may be point-to-point, point-to-multipoint or “ad-hoc.”

FIG. 12 illustrates an alternative preferred embodiment of the CPE device 1200 with a wireless communication link 1280 according to the present invention. The wireless communication link 1280 may transmit in a frequency band that does not generate significant adjacent channel interference or co-channel intersymbol interference with the wireless transceiver 175 of the CPE device 170 of FIG. 1. The wireless communication link 1280 communicates with a compatible wireless subscriber device 1285, such as a personal computer or handheld device with an integrated spread spectrum transmission component 1250.

For example, referring to FIG. 1, within a DSSS environment, the wireless transceiver 175 of the CPE device 170 may communicate with the transmission cell 135 using channel 1 (2412 MHz) of the 2.4 GHz (ISM) frequency band while the wireless communication link 1280 communicates in tandem with a compatible wireless subscriber device 1285 using a non-contested channel, such as channel 11 (2462 MHz), within the same 2.4 GHz (ISM) frequency band.

Similar in-band spread spectrum transmission within other frequency bands, such as the 5 GHz (UNII) frequency band, and using other transmission modulations, such as frequency hopping modulation or QAM modulation, is equally applicable.

Alternatively, the wireless transceiver 175 of the CPE device 170 may communicate with the transmission cell 135 using the 2.4 GHz (ISM) frequency band and employing DSSS modulation or a frequency hopping modulation while, concurrently, the wireless communication link 1280 of the CPE device 170 communicates with a compatible wireless subscriber device 1285 employing a frequency hopping modulation, such as frequency hopping spread spectrum (FHSS) or Bluetooth, in the 2.4 GHz (ISM) frequency band. The low-power implementation of frequency hopping modulation in the wireless communication link 1280 allows for interference-free operation of the wireless transceiver 175 to the transmission cell 135 and interference-free operation of the wireless communication link 1280 to a wireless subscriber device 1285 in the same frequency band without a major reduction in connectivity performance of the CPE device 170.

Alternatively, the wireless transceiver 175 of the CPE device 170 may communicate with the transmission cell 135 using the 5 GHz (UNII) frequency band while the wireless communication link 1280 communicates in tandem with a compatible wireless subscriber device 1285 using the 2.4 GHz (ISM) frequency band. The low-power implementation of 2.4 GHz transmission in the wireless communication link 1280 allows for interference-free operation of the wireless transceiver 175 to the transmission cell 135 and interference-free operation of the wireless communication link 1280 to a wireless subscriber device 1285 without a reduction in connectivity performance of the CPE device 170.

Alternatively, the wireless transceiver 175 of the CPE device 170 may communicate with the transmission cell 135 using the 2.4 GHz (ISM) frequency band while the wireless communication link 1280 communicates in tandem with a compatible wireless subscriber device 1285 using the 5 GHz (UNII) frequency band. The low-power implementation of 5 GHz transmission in the wireless communication link 1280 allows for interference-free operation of the wireless transceiver 175 to the transmission cell 135 and interference-free operation of the wireless communication link 1280 to a wireless subscriber device 1285 without a reduction in connectivity performance of the CPE device 170.

Alternatively, the wireless transceiver 175 of the CPE device 170 may communicate with the transmission cell 135 using QAM modulation within a licensed frequency band, such as the MMDS or LMDS frequency band, while the wireless communication link 1280 communicates in tandem with a compatible wireless subscriber device 1285 using spread spectrum modulation within the same licensed frequency band.

The low-power implementation of spread spectrum transmission in the wireless communication link 1280 allows for interference-free operation of the wireless transceiver 175 to the transmission cell 135, and interference-free operation of the wireless communication link 1280 to a wireless subscriber device 1285 without a reduction in connectivity performance of the CPE device 170.

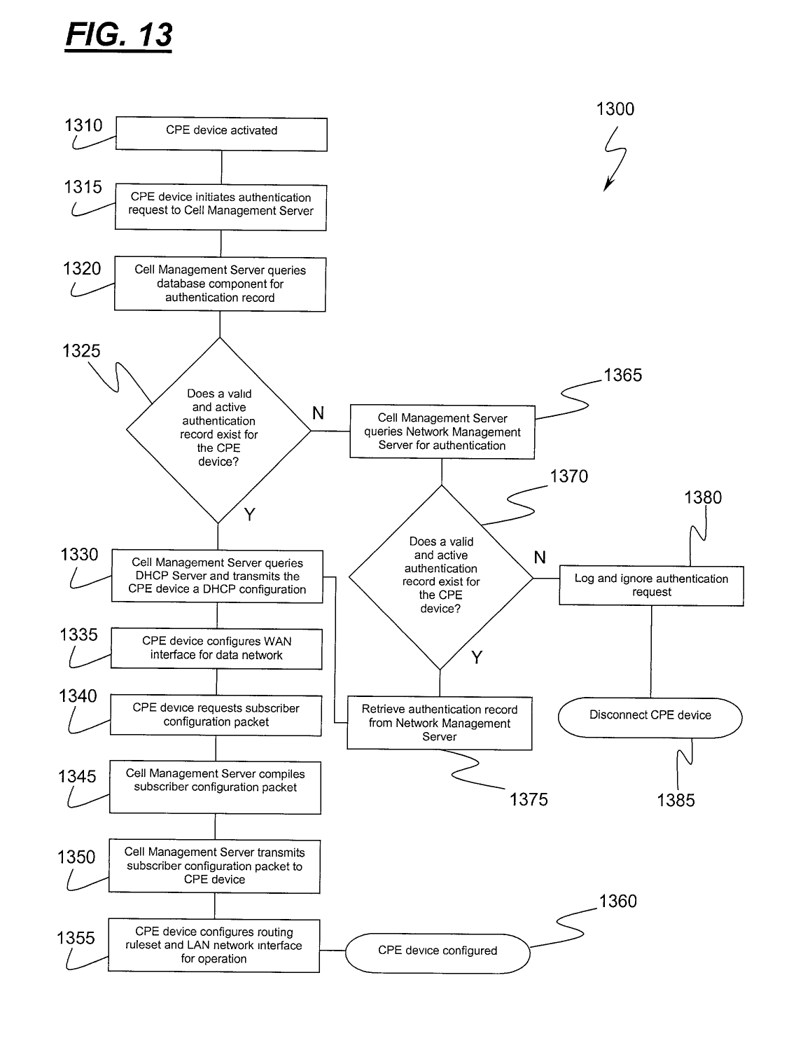

FIG. 13 illustrates a flowchart 1300 that represents a preferred embodiment of an authentication and configuration sequence for initializing a CPE device 170 to the data access system 100 according to the present invention.

First, at step 1310, the intended subscriber unpacks and activates the CPE device 170. Then, at step 1315, the CPE device 170 initiates an authentication request to the cell management server 524 of the transmission cell 135. This step allows the CPE to obtain an intra-cell private IP address through the use of IP masquerading or similar process. Additionally, this IP address can be derived from a nonspecific numeric pool or predetermined by the administrator of the data access system 100 to implement higher degrees of secure functionality such as additional authentication of the media access controller (MAC) address of the CPE device 170. Next, at step 1320, the cell management server 524 queries the database component 532 for authentication record corresponding to the intended subscriber's CPE device 170. At step 1325, a determination is made as to whether a valid and active authentication record of the CPE device 170 exists. If an active authentication record of the CPE device 170 is present, then at step 1330, the cell management server 524 queries the DHCP server and transmits a DHCP configuration packet to the CPE device 170. Next, at step 1335, the CPE device 170 configures its data network interface, such as a wide area network (WAN) interface. Then, at step 1340, the CPE device 170 may initiate a certificate-based transport or tunnel encryption method at the IP layer using a public key, such as IPSec or Layer 2 Tunneling Protocol (LT2P), and requests a subscriber configuration packet from the cell management server 524. Next, at step 1345, the cell management server 524 may initiate a certificate-based transport or tunnel encryption method 528 at the IP layer using a public key, such as IPSec or Layer 2 Tunneling Protocol (LT2P), and compiles the subscriber configuration packet. If a previous certificate-based connection has occurred, the cell management server 524 will verify the key of this connection against prior connections. Then, at step 1350, the cell management server 524 transmits the subscriber configuration packet to the CPE device 170. Next, at step 1355, the CPE device 170 configures its routing ruleset and network interface that preferably includes an IP addresses, DHCP configuration, DNS configuration, and firewall configuration for operation. A challenge-and-response routine may be initiated via the HTTP daemon application 1126 of the CPE device 170. Finally, at step 1360, the CPE has completed its configuration.

If, at step 1320, an active authentication record for the CPE device 170 is not found in the database component 532 of the transmission cell 135, then, at step 1365, the cell management server 524 queries the network management server 105 for the authentication record. Next, at step 1370, a determination is made as to whether a valid and active authentication record of the CPE device 170 exists in the database component 220 of the network management server 105. If an active authentication record of the CPE device 170 is present, then, at step 1375, the authentication record is retrieved from the network management server 105. Flow then proceeds to step 1330.

If, at step 1370, the network management server 105 does not contain a valid authentication record of the CPE device 170, then at step 1380 authentication request is logged and ignored. Finally, at step 1385, the CPE device 170 is disconnected.

Certain spread spectrum deployments, especially those deployments that transmit within public spectrum, may include components that are relatively inexpensive and readily attainable. Preferably, a variety of preventative measures may reside within the authentication routine of steps 1310-1325 of FIG. 13 to effectively resist theft of service of the data access system 100, such as theft of service resulting from cloning the CPE device 170 and its operation.

For example, the integration of a challenge-response method may preferably utilize an SSL-compliant HTTP daemon 1126 to provide a fundamental level of security by ensuring that related passwords, if applicable, are not compromised as well as to authenticate the legitimacy of the HTTP daemon 1126 of the CPE device 170. Additionally, a query may be dynamically generated to preferably include authentication variables such as subscriber identification, an indelible serial number of the CPE device 170, and a MAC address of the spread spectrum data conversion component 1112.

For example, in the case of a non-provisioned CPE device 170 and successive to CPE device activation of step 1310, the CPE device 170 may preferably query its own serial number as well as the MAC address of the spread spectrum data conversion component 1112. Additional information related to the transmission cell 135 and corresponding cell sector 150, 155, 160 of the CPE device 170 is also preferably retrieved and recorded within the authentication variables. The authentication variables of the newly-provisioned CPE device 170 are then preferably relayed to the transmission cell 135 and stored as an authentication record within the database component 532.

If, upon subsequent authentication requests by the CPE device 170, any of the authentication variables are incorrect, such as the variable that includes the serial number or cell sector 150, 155, 160 of the CPE device 170, or if the legitimate CPE device 170 has already been authenticated, the CPE device 170 preferably terminates its authentication routine and the failed attempt is preferably logged.

Preferably, the initial authentication routine of a non-provisioned CPE device 170 as described above results in geographically binding each CPE device 170 to the respective transmission cell 135 and cell sector 150, 155, 160 where it is originally activated.

Hence, the authentication routine preferably renders theft of service via cloning of the CPE device 170 decidedly more difficult, given that the attacker is required to compromise a variety of authentication variables while inhabiting the same geographical transmission cell 135 and cell sector 150, 155, 160 as the legitimately provisioned subscriber of the data access system 100. In effect, this level of security preferably mandates authentication of the CPE device 170 itself coupled with its geographical location, as opposed to merely verifying the serviceability of a particular subscriber of the data access system 100.

Some of the points of novelty of the preferred embodiment of the present invention may be expressed in terms as the “Five C's” of a viable provider-caliber data access solution. Namely, these are Cost, Capacity, Coverage, Control, and Compliance. Some of the present points of novelty with regard to each of the Five-C's is further discussed below. Currently, no spread spectrum access solution collectively incorporates the features discussed below.

With regard to cost, the preferred embodiment's solution elements (CPE, Cell) may maximize value by incorporating standard off-the-shelf or “Wi-Fi-compatible” components that are cost-effective and readily available whenever possible. This is referred to above with reference to the access node component 542, 544, 546 disclosure of FIG. 5 as well as the spread spectrum data conversion component 1112 disclosure of FIG. 11A. Additionally, because the present solution is preferably designed modularly, the preferred embodiment of the present solution includes the ability for the solution to transmit over different frequencies or modulations through a simple replacement of off-the-shelf components. The preferred embodiment of the present solution may transmit at 2.4 Ghz or 5.8 Ghz and may use any of Direct Sequence Spread Spectrum (DSSS) modulation, Frequency Hopping Spread Spectrum (FHSS) modulation and Orthogonal Frequency Division Multiplexing (OFDM) modulation.

With regard to capacity, the preferred embodiment of the present solution may incorporate client-side and server-side DNS and/or HTTP caching which contributes towards conserving transmission bandwidth. Caching increases the user capacity of the data network as described above with regard to the cache server 534 of FIG. 5 and the DNS caching daemon 1128 of FIG. 11A. Additionally, the solution preferably incorporates a proprietary spread spectrum polling medium access layer (MAC), as discussed above, that provides for the effective and equitable distribution of bandwidth among network clients. Additionally, the integration of sectorization and/or channel filtering (collectively disclosed in FIGS. 1, 3, 4, 5, 6, 7, 9C, 9F, 9G, 9H, 10, above) within a single, integrated spread spectrum access solution significantly contributes towards the dense user deployment of a reliable spread spectrum data access solution by increasing the number of available channel alternatives for spread spectrum data transmission. Thus, the system may be optimized even after deployment to respond to interference or user conditions to optimize data capacity. Additionally, the integration of a certificate-based encryption method (as discussed above as 528 of the transmission cell of FIG. 5 and 1134 of the CPE device of FIG. 11A) within the data stream of the spread spectrum access solution significantly reduces the occurrence of service compromise, which would appreciably diminish the available bandwidth of the data access solution.

With regard to coverage, as with capacity, service coverage is extensively enhanced via the integration of sectorization and channel filtering (as collectively disclosed above in FIGS. 1, 3, 4, 5, 6, 7, 9C, 9F, 9G, 9H, 10) within a single, integrated spread spectrum access solution. Sectorization significantly contributes towards the pervasive deployment of a reliable spread spectrum data access solution by increasing the number of available channel alternatives for spread spectrum data transmission. Additionally, the implementation of a spread spectrum frequency optimization utility as illustrated in FIG. 10 radically diminishes the occurrence of adjacent channel or co-channel interference that is common within spread spectrum transmission environments, and thus also increases coverage. Additionally, the integration of an AGC power amplifier (as shown above as 572, 574, 576 within the transmission cell sectors of FIG. 5 and/or the AGC power amplifier 1110 of the CPE device of FIG. 11A) increases the range of spread spectrum transmission. To date, no other spread spectrum solution offers power amplification as an integrated component of its operational capacity or scope. The integrated AGC capability also pertains to the category of compliance and is further discussed below.

With regard to control, the integration of a central management element (i.e. the Network Management Server 200 of FIG. 2) that remotely authenticates, provisions, and manages the functionality of a spread spectrum network is a vast improvement over the prior art. Additionally, the use of a central management element that operates regardless of the data trunk used between the cell and the management element is complete absent from the prior art. That is, the preferred embodiment of the present solution is “provider agnostic” and may be implemented with any trunk, including DSL, cable, optical, microwave, etc. all within the same network. No other solution provides similar flexibility. Additional functionality including remote management of the transmission cell, CPE provisioning, user authentication, IP address allocation, routing ruleset, and user bandwidth limitations is also novel. Additionally, the option of integrating the management element so that the management element resides at the cell (as discussed above with reference to FIG. 5) is also not found in the prior art. Additionally, no other spread spectrum solution offers a management element that includes a firewall, frequency optimization utility, encryption method, database component, and cache server as an integrated facet of its operational capacity or scope. Additionally, no other solution offers pervasive management of the data access system via a standard web browser (such as the Web Interface Application 250 of FIG. 2) that remotely manages the Network Management Server 200 of FIG. 2 and consequently the various elements (which includes the transmission cells and subscriber CPE) of the data access system at large. Finally, no other solution offers the authentication or provisioning routine of FIG. 13 that effectively binds each CPE to its respective cell and cell sector, rendering theft of service via theft of the CPE device or cloning of the CPE device decidedly more difficult.

With regard to compliance, compliance largely relates to the FCC specification for spread spectrum transmission within the 2.4 Ghz ISM or 5.8 GHZ UNIII bands. More particularly, the specification that directly pertains towards the allowed power level of transmission (measured in dBm) within said spectrum. The fact that the preferred embodiment of the present spread spectrum access solution that incorporates an AGC power amplifier (572, 574, 576 within the transmission cell sectors of FIG. 5 and the AGC power amplifier 1110 of the CPE device of FIG. 11A) as an integrated element of the data access solution at large provides a novel feature to optimize communication while ensuring compliance. As described above, the incorporation of the AGC allows for a fixed output of gain which allows for a variety of gain levels within the intermediate frequencies while ensuring that the transmission of the cell sectors comply with FCC regulation. Additionally, the incorporation of an AGC amplifier as an integrated element of the CPE is also novel and proves for the optional integration of spread spectrum conversion components operating at a variety of gain levels.

While particular elements, embodiments and applications of the present invention have been shown and described, it is understood that the invention is not limited thereto since modifications may be made by those skilled in the art, particularly in light of the foregoing teaching. It is therefore contemplated by the appended solution allows the integration of a web-based front-end utility (claims to cover such modifications and incorporate those features that come within the spirit and scope of the invention.

1. A data access system including:
a network management server receiving communication data from a data source;
a transmission cell receiving said communication data from said network management server, spread-spectrum encoding said data, and transmitting said spread-spectrum encoded data; and
at least one Consumer Premises Equipment (CPE) receiving and decoding said spread-spectrum encoded data,
wherein said transmission cell is partitioned into sectors and wherein the frequency of operation of at least one sector is dynamically configurable.

2. The data access system of claim 1 wherein said data source is the internet.

3. The data access system of claim 1 wherein said transmission cell is segmented into three sectors, each sector operating at a different frequency.

4. The data access system of claim 3 wherein each of said sectors is dynamically configurable.

5. The data access system of claim 1 wherein said CPE determines the signal to noise ratio (SNR) of received data.

6. The data access system of claim 5 wherein said transmission cell periodically polls said at least on CPE to retrieve the SNR.

7. The data access system of claim 6 wherein the SNRs of each CPE in a sector of said transmission cell are averaged and compared to a threshold to determined when the sector is affected by interference.

8. The data access system of claim 7 wherein said sector begins using a new frequency of operation in response to said threshold determination.

9. The data access system of claim 8 wherein said transmission cell is segmented into three sectors, each sector operating at a different frequency, and wherein said new frequency of operation is part of a predetermined revised frequency plan for each of said sectors in said transmission cell.

10. The data access system of claim 9 further including a plurality of transmission cells, and wherein said new frequency of operation is part of a predetermined revised frequency plan for a plurality of said transmission cell.

11. A data access system including:
a network management server receiving communication data from a data source;
a transmission cell receiving said communication data from said network management server, spread-spectrum encoding said data, and transmitting said spread-spectrum encoded data; and
at least one Consumer Premises Equipment (CPE) receiving and decoding said spread-spectrum encoded data,
wherein said network management server provides remote management of said at least one CPE.

12. The data access system of claim 11 wherein said network management server adjust a bandwidth allocation to said CPE.

13. The data access system of claim 11 wherein said network management server configures the IP address for said CPE.

14. The data access system of claim 11 wherein said network management server interfaces with payment information linked to a CPE to determine access control for said CPE.

15. The data access system of claim 11 wherein said network management server additionally provides management of said transmission cell.

16. The data access system of claim 15 wherein said transmission cell includes a plurality of sectors and said network management server alters the frequency of operation of at least one sector.

17. The data access system of claim 15 further including a plurality of transmission cells, a plurality of said transmission cells having a plurality of sectors, and wherein said network management server alters the frequency of operation of at least one sector of a plurality of said transmission cells.

18. A self-provisioning Consumer Premises Equipment (CPE) of a data access system, said CPE including:
a wireless transceiver receiving a spread spectrum encoded data signal from a transmission cell of a data access system and transmitting a spread spectrum encoded data signal to a transmission cell of a data access system;
a power amplifier performing automatic gain control (AGC) to control the amplitude of said signal transmitted to said transmission cell;
wherein said CPE is self-provisioning to establish communication with said data access system at an initial activation.

19. The CPE of claim 18 wherein said CPE is in remote communication with a network management device and said network management device manages CPE.

20. The CPE of claim 18 where in said transmission cell includes a plurality of sectors and wherein said CPE identifies which sector it occupies during self-provisioning.
